(19) United States
(12) Patent Application Publication
(10) Pub. No.: US 2008/0300981 A1
(43) Pub. Date: Dec. 4, 2008

(54) CAMPAIGN OPTIMIZATION

(76) Inventors: Robert Crites, Mechanicsburg, PA (US); Mukul Goyal, Walpole, MA (US); Glen Osterhout, Somerville, MA (US); Ruby Kennedy, Bedford, MA (US); Francisco Jauffred, Weymouth, MA (US)

Correspondence Address: FISH & RICHARDSON PC, P.O. BOX 1022, MINNEAPOLIS, MN, 55440-1022, US

(21) Appl. No.: 12/048,609

(22) Filed: Mar. 14, 2008

Related U.S. Application Data
(60) Provisional application No. 60/941,355, filed on Jun. 1, 2007.

(51) Int. Cl. G06Q 30/00

(52) U.S. Cl. 705/14

(57) ABSTRACT

Methods, systems, and software for combinatorial optimization are described. A first combination of offers are selected from a list of combinations of offers that pass a first set of rules belonging to a first category of rules, and it is determined whether the first combination of offers passes a second set of rules belonging to a second, different category of rules. If the first combination passes the second set of rules, the first combination is returned as a solution.

### RELATED APPLICATION

This application claims the benefit of U.S. Provisional Application No. 60/941,355, filed Jun. 1, 2007. The entire teachings of the above application are incorporated herein by reference. This application is also related to presently pending application Ser. No. 10/015,548, filed Dec. 11, 2001, the entire teachings of which are incorporated herein by reference.

### BACKGROUND

This invention relates to contact stream optimization (CSO), and more particularly to determining assignments of offers to customers for a marketing campaign.

In a marketing campaign, combinations of different possible offers (e.g., advertisements, and promotional offers) may be sent to individuals identified as potential customers. Marketing campaign optimization typically takes a set of possible offers and a set of potential customers, along with the characteristics and constraints of the marketing campaign, one or more scores (any numeric value that represents the relative value of giving a particular offer to a particular recipient) and determines which offers should go to which customers to maximize the sum of scores of the surviving transactions while fulfilling all constraints. The result of the marketing campaign optimization may be a listing of offers assigned to individual potential customers. This listing is referred to as a “contact stream.”

### SUMMARY

The invention provides systems and methods, including computer program products, for combinatorial optimization.

In general, in one aspect, the invention features a method and software encoded on computer-readable medium. The method includes selecting a first combination of offers from a list of combinations of offers that pass a first set of rules belonging to a first category of rules, where the offers in the list of combinations of offers have assigned scores associated with sending the offers to proposed contacts; and determining whether the first combination of offers passes a second set of rules belonging to a second, different category of rules. If the first combination violates one or more rules of the second set of rules, one or more of the offers of the first combination are modified to generate a second combination of offers that complies with the second set of rules. However, if the first combination passes the second set of rules, the first combination is returned as a solution.

In general, in another aspect, the invention features a system including memory configured to store a list of combinations of offers that pass a first set of rules belonging to a first category of rules, where the offers in the list of combinations of offers have assigned scores associated with sending the offers to proposed contacts; and one or more processors configured to: select a first combination of offers from the list; and determine whether the first combination of offers passes a second set of rules belonging to a second, different category of rules. If the first combination violates one or more rules of the second set of rules, the one or more processors modify one or more of the offers of the first combination to generate a second combination of offers that complies with the second set of rules. If, however, the first combination passes the second set of rules, the one or more processors return the first combination as a solution.

Embodiments may include one or more of the following. The solution may be applicable to a marketing campaign. The first category of rules may include min rules, which specify that at least M offers from set S of offers are sent to any contact of the marketing campaign or that a first offer may only be included with a second offer, and the second category of rules may include max rules, which specify that no more than M offers from set S of offers may be sent to any contact of the marketing campaign. Modifying one or more of the offers may include violating a first rule of the first set of rules to comply with a second rule of the first set of rules, and modifying the result to comply with the first rule. Modifying may include removing the one or more offers from the first combination of offers; and/or replacing the one or more offers of the first combination with one or more different offers. Modifying may include determining information associated with how the one or more rules of the second set of rules are violated by the one or more offers of the first combination; and using the information to modify the one or more offers.

The rules of the first and second sets of rules and the first combination may be represented by strings of bits corresponding to offers, and modifying may include: performing an AND operation between the bits of the one or more rules that are violated and the bits of the first combination of offers to generate a combo set, wherein the combo set includes a combo set including a set of “on” bits and any intervening bits; adjusting bits outside the combo set according to rules that govern how violated rules of the first category may be repaired; and returning the combo set as the second combination of offers.

The combinations of offers may be organized in the list in descending order according to scores associated with the combinations of offers such that the first combination of offers has a score that is higher than the scores of the other combinations in the list. The second set of rules may be ordered by the most restrictive first; and each rule of the second set may be applied, one by one and in order, to the first combination. The list of combinations of offers that pass a first set of rules may be organized as a tree structure, and the next highest scoring combinations of offers may be generated one at a time and on-demand; and stored in the tree structure.

The method may include iteratively (1) applying the first set of rules to combinations of offers that pass the second set of rules, modifying the combinations to comply with one or more of the first set of rules; and adding the modified combinations to the list; and (2) applying the second set of rules to combinations of offers in the list in descending order according to scores associated with the combinations of offers; modifying the combinations to comply with one or more of the second set of rules, until a final combination that satisfies both sets of rules is determined, the final combination being an optimal solution to a marketing campaign.

The details of one or more embodiments are set forth in the accompanying drawings and the description below. Other features, objects, and advantages will be apparent from the description and drawings, and from the claims.

### DESCRIPTION OF DRAWINGS

FIG. 1 is a block diagram of a computer system executing campaign management software including contact optimization software.

FIG. 2 is a block diagram of a server for use with the computer system of FIG. 1.

FIG. 3 is a block diagram of a campaign optimization process.

FIG. 4 is a block diagram of a component for solving contact optimizations for-each-customer (FEC).

FIG. 5A is a block diagram of a table of records.

FIG. 5B is a diagram of a record.

FIG. 6 is a flow chart of a contact optimization process.

FIG. 7 is a flow chart of an alternative generation process.

FIG. 8 is a flow chart of an “integrated mins” algorithm.

FIGS. 9-15 are flow charts showing processes of the integrated mins algorithm in further detail.

FIGS. 16A-H are flow charts showing an application of the integrated mins algorithm.

### DETAILED DESCRIPTION

An algorithm for campaign optimization includes enhancements built upon the foundation of “Method for Contact Stream Optimization” Ser. No. 10/015,548 filed 12-11-2001 the contents of which are incorporated herein by reference in their entirety.

Campaign optimization begins with a set of marketing offers, which can include advertisements and promotional offers, and a pool of potential recipients (also referred to as “customers”), which may include existing customers and new individuals. The offers are produced independently of the optimization process and typically have a number of financial characteristics (costs, delivery channel, risk, etc.). For each of the offers, the process calculates a score that represents the relative “value” of assigning any particular offer to any individual customer. The score can take a number of forms, including the probability that the customer will respond to the offer or an expected value of the offer for the customer. The potential list of contacts is the “proposed contact list” and may include all permutations or a subset of permutations (i.e., an external system may apply eligibility rules to the list to reduce the number of proposed contacts to consider for optimization).

The set of assignments of offers to customers in the customer pool represents a solution, and the sum of scores corresponding to the assignments is referred to as the “overall campaign score.” Campaign optimization seeks to find a solution that optimizes the overall campaign score while satisfying a given set of rules/constraints (hereinafter rules and constraints are used synonymously). In other words, a set of assignments is considered to be optimal if the set maximizes the overall campaign score while honoring all constraints. The details of the optimization process are described further below.

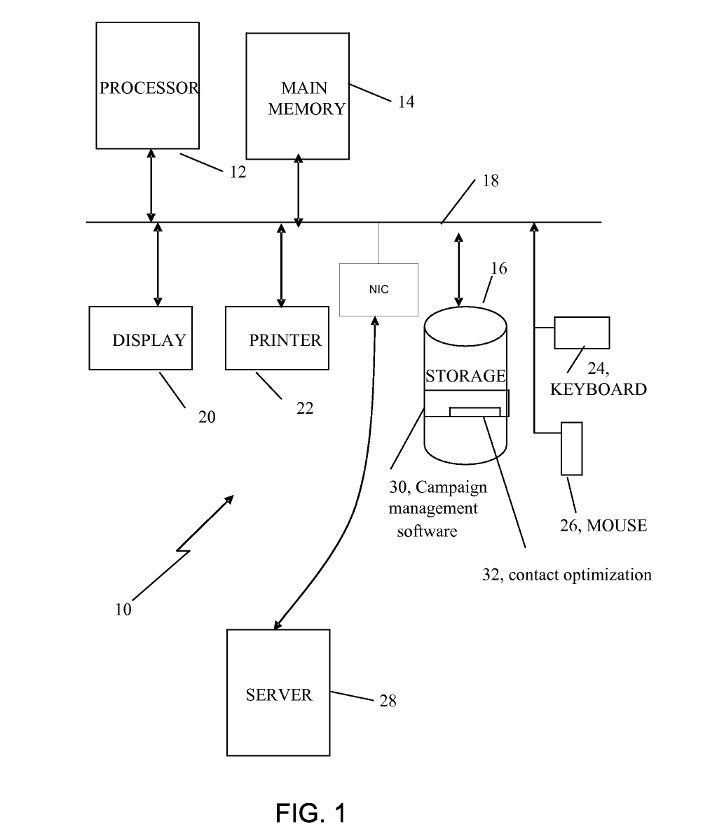

Referring now to FIG. 1, a computer system 10 includes a CPU 12, main memory 14 and persistent storage device 16 all coupled via a computer bus 18. The system 10 also includes output devices such as a display 20 and a printer 22, as well as user-input devices such as a keyboard 24 and a mouse 26. Not shown in FIG. 1, but necessarily included in a system of FIG. 1, are software drivers and hardware interfaces to couple all the aforementioned elements to the CPU 12.

The computer system 10 also includes automated campaign management software 30 that includes contact optimization software 32 that prioritizes offers sent to multiple contacts based on given criteria. The contact optimization software 32 provides a streamlined technique that in some scenarios, executes faster than purely linear programming solutions, and that can find an optimal solution if there are no cross-customer capacity constraints (e.g., limits on the number of customers per offer or number of emails/calls made in any time period) or a nearly optimal solution otherwise.

The contact optimization software 32 supports several types of rules, among other rules: (1) exclusion rules (2) for-each-customer (FEC) rules and (3) cross-customer (CC) capacity constraints. Exclusion rules or “eligibility constraints” are examples of rules that are applied with respect to each current offer and considered independently. The rules are represented by expressions having arithmetic, relational, logical, and/or other operators acting upon customer input data. An example is a customer meeting a minimum salary requirement. These type of constraints can also be used to implement temporal constraints among offers, e.g., if a customer received offer X within the past 3 months (according to the customer input data), then they are not currently eligible to be sent offer Y Exclusion rules can be efficiently implemented at the database query level to select the subset of proposed assignments that undergo further optimization.

FEC rules are customer-specific and in general are different from customer to customer. FEC rules can be evaluated in the context of a single customer at a time, looking only at the proposed contacts and contact history for that single customer. Examples of FEC rules include, but are not limited to, a maximum or minimum number of offers or packages for a particular customer, incompatible offers (e.g., invalid combinations of offers), specific sequences of offers (e.g., a telephone follow-up call can only be sent if the original direct mail offer is also sent, and a “positive” offer must be spaced a minimum number of days after any “negative” offer).

FEC rules may also impose limits on the number of offers sent to a customer over a specific time period (e.g., a fixed or sliding time window), using a particular channel, and/or of a certain offer type. These types of FEC rules reduce or eliminate contact fatigue so that among other reasons customers do not feel bombarded with offers. The limits imposed by the FEC rules vary among customers. Application of FEC and CC rules may be limited based on various other dimensions (e.g., customer segments, channels, offer sets, cost/budget, and/or time). For example, an FEC rule could specify that customers that have never before responded to an email offer cannot receive more than three type-A offers using the email channel per rolling 30-day period.

Cross-customer (CC) constraints are global in nature and represent a shared resource for customers in the campaign, e.g., budget, offer capacity, or channel capacity and/or other goals the campaign must meet (using multi-dimensional scores), for example a minimum average FICO score or maximum sum of risk score in a campaign sending out credit offers.

The automated campaign management software 30 and contact optimization software 32 may reside on the computer system 10, as shown, or may reside on a server 28 that is coupled to the computer system 10, e.g., over a network through a network interface card (NIC), in a conventional client-server arrangement. Databases that supply data to the campaign management software 30 and contact optimization software 32 can reside on the storage 16 on a storage device (not shown) associated with server 28 or as networked-based databases that are accessed by the client 10 and/or the server 28, as appropriate and as would be known to one of ordinary skill in the art.

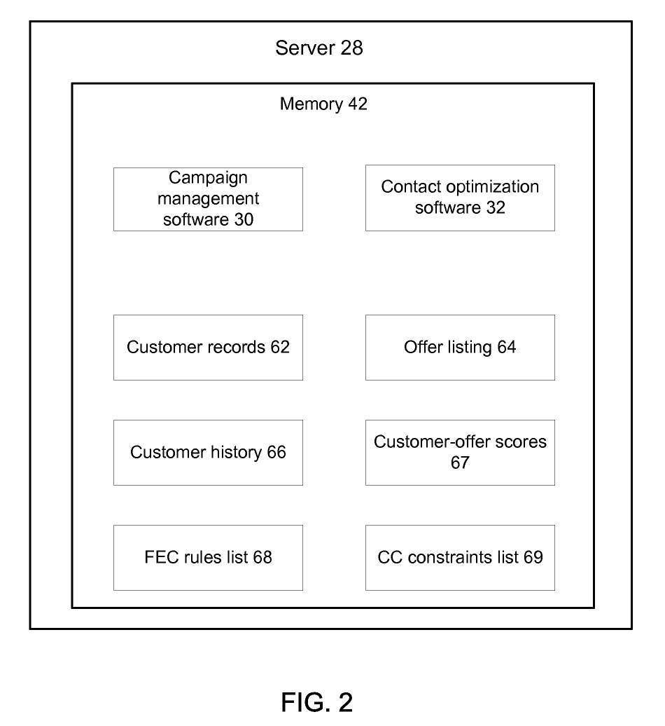

Referring now to FIG. 2, the memory 42 has resident therein the campaign management software 30 and contact optimization software 32 that executes the optimization process. The memory also can include input data used by the optimization process. This data includes customer records 62 for a pool of customers to be considered as contacts for a marketing campaign; a listing of offers 64 to be provided to the customers; and customer history 66 for one or more customers in the pool. The customer history 66 is used by FEC rules or CC constraints when evaluating potential offers over time. The customer history 66 stores a complete record of all previous contacts made to customers, including any relevant data for optimization (e.g., offer, offer attributes, contact date, contact channel, contact cost, etc.). For optimization, there must be a set of customer-offer scores 67. The customer-offer scores 67 may be independently calculated (e.g., using a predictive model), based on rules (e.g., DB calculations or derived fields from the campaign management software 30), or provided by a user in the contact optimization software 32. An FEC rules list 68 contains all applicable FEC rules for the current campaign and a CC constraints list 69 contains all applicable CC constraints for the current campaign.

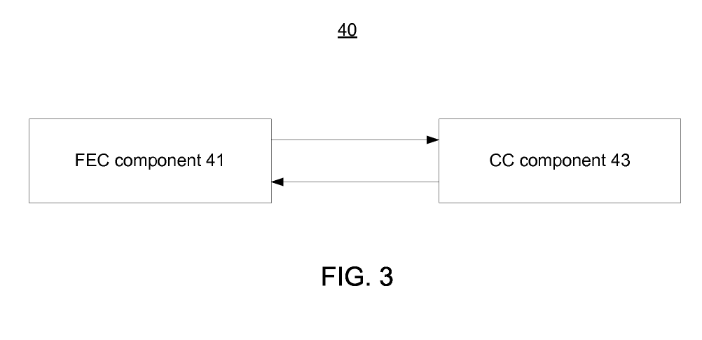

Referring now to FIG. 3, a campaign optimization process 40 includes a component 41 for solving contact optimizations for each customer (an FEC-based contact stream optimization) and a component 43 for solving CC constraints. In some embodiments, the CC component 43 may do pre- or post-processing such as described in application Ser. No. 10/015,548, “Method for Contact Stream Optimization.” In other embodiments, the CC component 43 may modify the scores used by the FEC component 41, by applying Lagrange Multipliers or by some other means, possibly in an iterative fashion. An example of this can be found in application Ser. No. 11/970,776, “Contact Stream Optimization.” The FEC component 41 can also be used in a standalone mode in cases where there are no CC constraints. The focus of the present patent is on the FEC component 41.

Both FEC rules and CC constraints can specify an interval of time, referred to as a “window,” constraining the rule (e.g., to control offer spacing to reduce the possibility for contact fatigue, among other purposes). Windows can be static (i.e., referencing a specific fixed set of dates such as Jan. 1, 2007-Jan. 31, 2007) or “dynamic/sliding” which is interpreted as any time period of the specified length. Sliding windows are typically more relevant to marketers. For example, a rule stating a maximum of one offer is allowed in January and one offer in February would not preclude an offer given to an individual on January 31^{st} and February 1^{st}, even though these are two consecutive days. A more meaningful interpretation of the rule, invoking sliding windows, would say that only one offer is allowed in any 30-day window. Time windows are defined by start and end dates and are determined by the time interval specified in the rule, and by the distinct dates of the proposed offers and contact history to which the rule applies. Rules that specify a time interval are applied independently to the transactions within each time window; as if the same as if a separate rule had been created with a start and end date as part of its definition for every time window.

1. There must be at least one non-history transaction within its date range

2. The time window must be distinct for this time interval and set of distinct dates:
a. The set of transactions within its date range must not be equivalent to that of any other time window.
b. The set of transactions within its date range must not be a subset of that of any other time window.
   In the case of FEC rules, the windows may be specific to a particular customer. For CC rules, the windows may be applicable to all customers or a subset of customers.

The FEC rules are translated into “internal” rules, or rules that the FEC-CSO algorithm can process. FEC-CSO Examples of internal rules include:
Max(M,S) Rules: These rules specify that no more than M offers from set S of offers may be sent to a customer. For example, channel constraints are a particularly useful capability provided by Max(M,S) rules, e.g., if at most one offer can be sent via email, and offers 3, 4, and 6 are email offers, this constraint can be enforced as the following rule: Max(1, {3,4,6}).
“Not A with B” Rules: These rules specify that a customer may not receive both type A and type B offers (A and B may each represent a single offer or a set of offers). Mutually exclusive offers can be accommodated most efficiently with this type of rule.
Max Transaction Sets Rules: If the transactions are grouped into sets (for example, all transactions that belong in the same package might constitute one set), these rules specify a maximum number of sets for a customer. This type of rule efficiently handles “interruptions” for managing contact fatigue when multiple offers are presented in the same delivery vehicle or “package.”
Min(M,S) Rules: These rules specify that at least M offers from set S of offers must be sent to a customer.
“B only with A” Rules or “BOWA” Rules: A BOWA rule specifies that type B offers may not be sent to a customer unless type A offers are also sent (A and B may represent a single offer or a set of offers). In marketing, this type of rule ensures a “follow-up telemarketing call for offer X” cannot be made unless the initial direct mail offer for X has already been made.

Internal rules operate at the level of transactions and/or sets of transactions, where a transaction is typically the intersection of an offer, customer, channel, and date (other attributes such as cost/budget are also possible). Each proposed offer is a transaction, because it is proposed to a particular person on a particular channel on a particular date. The following list provides examples of specific FEC rules applied to sets of transactions A and B, and the internal rules derived from the FEC rules. Specification of a time window is optional for all of these rules; if no time window is specified, all proposed transactions are considered).

a) Never combine A with B:
This FEC rule is represented by the “Not A with B” internal rule. If there is a time interval specified, there will be one of these internal rules per relevant time window. For example, if there are type A transactions on Monday and Friday, and type B transactions on Tuesday and Thursday, and an FEC rule specifies that A and B transactions should not be combined within a two-day sliding window, these would be translated into two internal rules. The first internal rule would prevent the Monday and Tuesday transactions from both being selected. The second internal rule would prevent the Thursday and Friday transactions from both being selected. If the same transaction belongs to both sets, that transaction is automatically rejected. If a particular customer only has transactions from set A or from set B (but not both) in their proposed transactions and contact history, no internal rule is needed.

b) Never A Followed by B:
This FEC rule is implemented using the “Not A with B” internal rule. If there is a time interval specified, calculate the time windows. For each time window, check to see if there are any history A or B transactions within it. Find the earliest date among the history A's in the time window, and create a Max 0 internal rule for all B's in that time window with later dates. Set the trailing edge of the time window to the date of the earliest history A. Find the latest date among the history B's in the time window, and create a Max 0 internal rule for all A's in that time window with earlier dates. Set the leading edge of the time window to the date of the latest history B. If the leading edge of the adjusted time window no longer precedes the trailing edge, we are done with this time window. If we still have a valid time window, we need to create the minimal set of Never A with B internal rules that will provide the desired results. The pseudocode to do this is:

```
FOR EACH A not yet used in a rule
  Create a new empty rule
  initial date = current A's date
  Add all A's with this date to the rule
  FOR EACH distinct date after the initial date
  IF rule has no B's yet
    IF there are any B's with this date
    add all B's with this date to the rule
    ELSE
    add all A's with this date to the rule
    END IF
  ELSE
    add all B's with this date to the rule
  END IF
  END FOR EACH
  IF rule has both A's and B's
  save the rule
  END IF
END FOR EACH
```

c) B Only With A:
If there are no A's in the time window, all B's in that time window should be deleted. These are implemented as BOWA internal rules.

d) Max Offers:
This FEC rule can be implemented by Max(M,S) internal rules. The number of these rules is determined by the number of relevant time windows if there is a time interval specified.

e) Min Offers:
This FEC rule can be implemented by Min(M,S) internal rules. The number of these rules is determined by the number of relevant time windows if there is a time interval specified.

f) Max Duplicate Offers:
There is one Max(M,S) internal rule produced for each distinct offer in the proposed transactions. The number of these rules is determined by the number of relevant time windows if there is a time interval specified.

g) Max Packages:
This FEC rule is turned into a MAX Transaction Sets internal rule operating on packages (counting customer interruptions rather than offers). There is one internal rule per relevant time window if a time interval is specified.

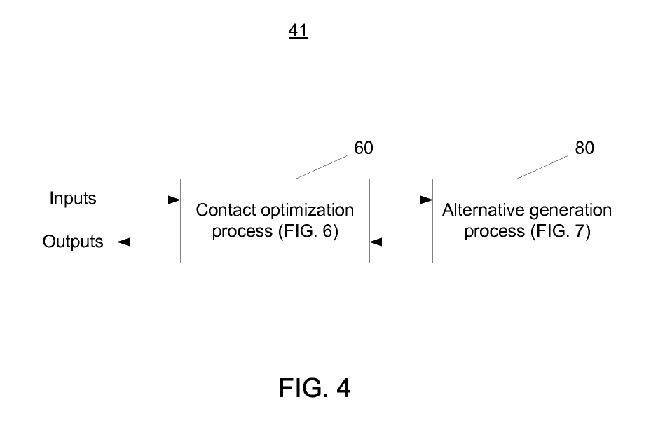

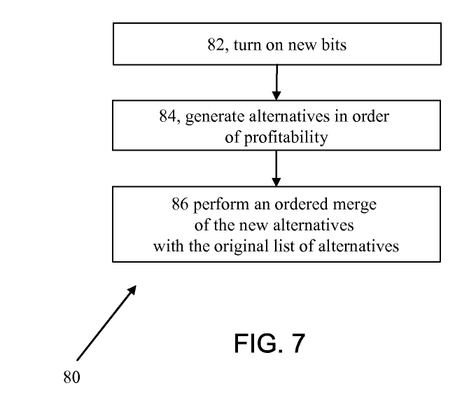

Referring now to FIG. 4, the FEC-CSO component executes a contact optimization process 60 that selects an optimal set of transactions (offers) to send to each customer. By “optimal” is meant that the set of offers to send are selected to maximize a specified score (e.g., profit), while satisfying any given internal rules. This process 60 is run for each customer individually. The inputs to this process typically include the scores for each offer, the channel, the contact date, and the internal rules (other attributes may also be included as input, such as offer cost or secondary scores used in other constraints). The outputs include a send/no-send flag for each transaction (offer), credit assignment information about which rule or rules were responsible for any no-send decisions, as well as a log file and other reporting information. If all rules are satisfied, the proposed solution is accepted for the customer and the process 60 evaluates the next customer. The contact optimization software 32 executes an alternative generation process 80 as set out in FIG. 7 whenever rules of the type Max(M,S) are violated by a proposed solution for a given customer.

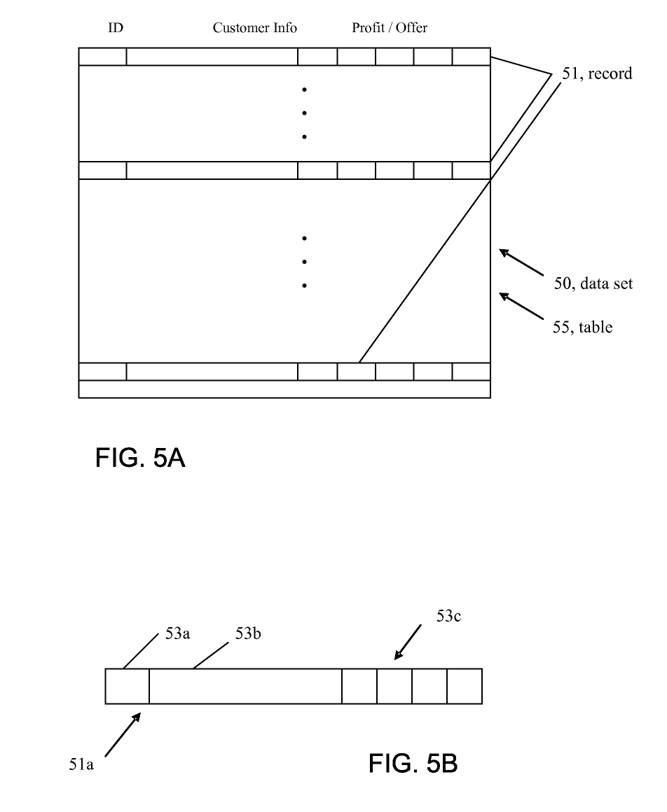

Referring now to FIGS. 5A and 5B, a data set 50 includes a plurality of records 51. A customer is represented by a record 51. The records 51 are organized into a table 55. The customer data inputs are stored in the records 51. The records 51 (FIG. 5A) include an identifier field 53a and a plurality of fields 53b containing customer information that may be needed for determining each customer's eligibility to receive each offer (or internal rules) or for computing the score value (e.g., expected profit from sending each customer each offer). The records 51 also include fields 53c for additional scores corresponding to offers that are used in the contact optimization process 32, that could have been previously computed. In the table 55, each record 51 represents a customer in rows of the table and each column represents information about the customers such as identifiers, eligibility information, expected profits from scores for the transactions, and so forth.

The score (e.g., expected profit) would be determined by modeling characteristics of the customer using one of many different types of algorithms, as mentioned above. The score could be based on their membership in a particular customer segment, or it could be the output from a model or some formulas for computing the expected profit. For example, a model might predict the response rate that is multiplied by the expected revenue from that particular offer. To determine the expected profit, the cost of sending that offer is subtracted from revenue.

Method for Contact Stream Optimization

In some embodiments, algorithms, such as the algorithm described in application Ser. No. 10/015,548, “Method for Contact Stream Optimization,” optimize assignments of offers to potential customers (also referred to as “contacts”) independently. These algorithms process rules for each customer in the form “Max(M,S)”, meaning “at most M offers are allowed from set S.” The algorithms are guaranteed to find the optimal solution. Set forth below is a high-level description of one such algorithm:

For each customer:

1. Weed out any illegal offers.

2. Sort remaining offers by their scores (e.g., expected profit).

3. Consider the remaining sorted offers as a string of bits, with the leftmost bit representing the most profitable offer.

4. Propose the most profitable set of offers (e.g., all positive scoring offers) as the first “alternative”. Note that “alternative” refers to a proposed set of offers.

5. Check the alternative against the rules.

6. If unacceptable, what rule was violated?

7. Generate new alternatives based on how the rule was violated. Generate them in descending order of profitability, and merge them into a sorted list of alternatives.

8. Continue the generate-and-test cycle, looking at the highest scoring alternative generated to date, until an alternative is found that does not violate any rules. That alternative will be the optimal solution for this customer.

Other embodiments include enhancements to this basic scheme, including support for additional types of rules, more efficient ways of generating new alternatives in step 7, and additional ways of using this algorithm when the customers are not treated independently.

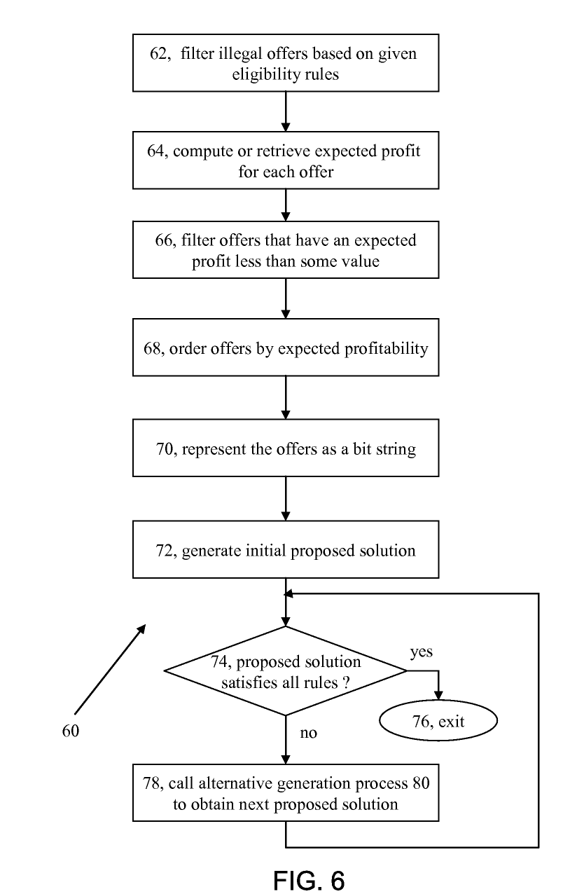

This process 60 is run for each customer individually. An example of the contact optimization process 60 is set out in FIG. 6 below. As will be described in FIG. 6, the contact optimization process 60 for each customer filters out illegal offers and orders remaining offers by score. The process 60 represents remaining offers as a bit string and generates an initial proposed solution that is checked against all Max(M,S) type rules. However, the process 60 does not consider Min[M,S] type rules. If all rules are satisfied the proposed solution is accepted for the customer and the process 60 evaluates the next customer. The contact optimization software 32 executes an alternative generation process 80 as set out in FIG. 7 whenever rules of the type Max(M,S) are violated by a proposed solution for a given customer.

Referring to FIG. 6, an example of the contact optimization process is shown. For each particular customer, the contact optimization process 60 filters 62 out any illegal offers based on given eligibility type rules as discussed above. One example given above was whether the current customer has a specified income level to receive the present offer and so forth. This filtering may also be performed earlier in the process, at the database query level. The contact optimization process 60 computes 64 the expected profit (score) for each offer for that particular customer unless it is provided, in which case the expected profit can be retrieved. The contact optimization process 60 filters 66 out any offers that have an expected profit less than or equal to zero or some other value. The contact optimization process 60 orders 68 the remaining offers by their expected profitability.

The contact optimization process 60 represents 70 the offers as a bit string. The length of the bit string is the total number of offers that are still valid for the customer after all of the filtering processes discussed above. The length of the bit string is the number of zeros and ones in the string with each bit representing one of the offers. The bits are ordered by the expected profit. Illustratively, assume that the left most bit is the most profitable offer and the right most the least profitable. A “one” indicates send the offer to that customer and a “zero” indicates do not send the offer.

The contact optimization process 60 starts by generating 72 the most profitable bit string as the initial proposed solution. The initial proposed solution is generated in a way that obeys any limit on the number of offers for the customer. For example, if “N” is the maximum number of offers for the customer, the initial proposed solution will be the string that has the first N bits as ones and bits thereafter as zeros. For example, if N=4 with 10 possible offers, the initial proposed solution will be (1111000000).

The contact optimization process 60 will test 74 to see if the proposed solution violates any rules or constraints of the “Max(M,S)” type. If that string does not violate any Max(M,S) type rules or constraints, then that is the answer and the process exits 76. Otherwise, the contact optimization process 60 will generate 78 the next most profitable alternative string as a proposed solution, which will be tested 74. The contact optimization process 60 will continue to generate and test alternative solutions in this manner until a solution is found that does not violate any rules or constraints.

When testing proposed solutions against Max(M,S) type rules, the contact optimization process 60 can achieve greater computational efficiency by ordering the Max(M,S) rules in an intelligent way. For example, the process 60 can give priority to testing rules that have the lowest values M and the largest sets S because evaluation of those rules against potential sets of offers most quickly tend to restrict the space of possible solutions.

Referring to FIG. 7, if there is some rule violated, the contact optimization process 60 calls 78 an alternative generation process 80 that generates one or more alternative solutions. In some embodiments, such as the one described in application Ser. No. 10/015,548, “Method for Contact Stream Optimization,” the alternative generation process 80 turns on 82 new bits that will be on in all of the alternative solutions generated. This process 82 of turning on new bits is necessary when the initial alternative does not contain all positive-scoring offers, such as when there is a maximum number of offers per customer that is applied while generating the initial alternative. In other embodiments, such as the enhanced embodiments described in this patent, the initial alternative will always contain all positive-scoring offers, and if there is any maximum number of offers per customer, it will be processed later like any other internal rule. In that case, the process 82 for turning on new bits is skipped. The alternative generation process 80 generates 84 alternative solutions in order of profitability, and performs 86 an ordered merge of the new alternatives with the original list of alternatives. The merge 86 essentially interleaves the alternatives with the original list as appropriate to retain the overall profitability order. That is, the alternative generation process 80 generates new alternatives in the order of profitability and merges them into an alternative list retaining the profitability order.

For example, the current list contains three alternative solutions with profitability “100”, “50”, and “25”. The alternative generation process 80 generates two additional alternative solutions with profitability “150” and “75”. By merging 86, the alternative generation process 80 retains the profitability order of the alternative solutions producing a new list ordered as “150”, “100”, “75”, “50”, and “25”.

Referring back to FIG. 6, the alternative solution with the highest profitability “150” is the next proposed solution to be tested 74 to see if all rules are satisfied.

Details of the actions of the alternative generation process 80 are set out below. The alternative generation process produces a set of new alternatives when a rule of the Max(M,S) type, i.e., “only M offers from set S are allowed” is violated. If such a rule is violated, some number of bits T greater than M bits from the set S were on. Call the rightmost one bit in the string, R1. In some embodiments, the alternative generation process turns on 82 (T−M) new bits that are not a part of set S changing the new offers from a zero bit to a one bit. The bits representing these offers immediately follow R1 until no more bits are left.

For example, the string (1111000000) represents sending the 4 most profitable out of 10 possible offers. In this example, the string violates a rule that says “only one of the first two offers” is allowed. That means that the first two offers are mutually exclusive. In this example, the rightmost one bit is the fourth bit hence R1 is four.

The alternative generation process 80 will turn on 82 (T−M) new bits. In this case M is “one”, because only one offer out of the offers from set S that contains offer one and offer two, is allowed. In the example string, (1111000000), a number T of those bits from set S are on (T is 2). Since the number T is greater than M (M is 1), the process turns on T−M new bits (2−1=1), i.e., one bit. That bit is not a part of set S and immediately follows bit R1 (bit 4). Let the rightmost new bit be called R2 (in this example R2=bit 5). The process 80 generates new alternatives based on all M bit combinations of the T bits up to R1 and any 0 bits in set S between R1 and R2. In the example, the alternative generation process 80 turns on bit number 5 because that bit immediately follows bit R1 and is not a part of set S.

If the alternative generation process 80 reaches the end of the string and there are no possible bits representing offers that the alternative generation process 80 could turn on, (case not shown) then the alternative generation process 80 does not turn on any more bits. In some cases, the alternative generation process 80 may need to turn on multiple bits.

After the alternative generation process 80 turns on a new bit, the alternative generation process 80 generates 84 an alternative list based on all bit combinations of the T 1 bits up to R1, and any zero bits in set S between R1 and R2. In this case, the T 1 bits (T is 2) are the first two bits. The alternative generation process 80 tries all possible combinations. All M bit combinations (for M=1) are tested, i.e., all the combinations where only one of the first two bits is turned on, either (10) or (01). In this case, there are two combinations that can be generated. The process 80 can use a mathematical function for the number of combinations of T elements taken M at a time,

C(T,M)=T!/(M!*(T−M)!),

to determine how many different alternatives will be generated, e.g., C(2,1)=2.

The alternative generation process 80 generates these alternatives in order of profitability. In this case, with only two alternatives, the (10) alternative has to be better than the (01) alternative because the process has ranked the offers by profitability.

However, in cases where multiple bits are turned on, the combinations often need to be further examined. For example, where 2 out of 4 bits can be turned on, there are 6 combinations and the alternative generation process 80 generates 84 the combinations (1100), (1010), (1001), (0110), (0101), and (0011). All of the combinations are generated in order with the possible exception of the (1001) and (0110) combinations. The combinations are generated in order when more profitable bits are only swapped with less profitable bits. The combinations are not necessarily generated in order when both more and less profitable bits are swapped to generate a new combination as in the (1001) and (0110) combinations.

In that case, the process 84 performs a comparison. In the example, the process 84 compares the sum of the profitability of the first offer and the fourth offer to the sum of the profitability of the second offer and the third offer. Even though the individual offers are already ranked the process performs the additional comparisons to maximize the total profitability of the set of offers.

Some examples of generating new alternatives are shown below.

### EXAMPLE

If ordered bit string of offers (1111000000) violates a rule Max(1, {1,2}), which means that offers 1 and 2 are mutually exclusive, the sorted alternatives generated would be: (1011100000) and (0111100000).

If ordered bit string (1011100000) then violates another rule Max(2, {3,4,5,7}), meaning that only 2 offers from the group of offers 3, 4, 5 and 7 can be sent, the sorted alternatives generated would be: (1011010000), (1010110000), and (1001110000), which would be merged with the already sorted list containing (0111100000).

However, if the ordered bit string (1011100000) violated another rule Max(2, {3,4,5,6}), the alternatives generated would be: (1011001000), (1010101000), (1010011000), (1001101000), (1001011000), and (1000111000).

If the ordered bit string (0010001100) violated another rule Max(2, {3,4,6,7,8,10}), the sorted alternatives generated would be: (0010001010), (0010000110), and (0000001110).

The algorithm uses information about the way that a rule was violated to generate new alternatives. The algorithm generates these new alternatives automatically in order of profitability and in some cases using a sorting procedure to rank in order of profitability. If there are T bits on from set S, where T>M, then T-choose-M new alternatives are generated, each with only M bits on from S. The order in which the rules are processed may affect the speed of the algorithm, but will not affect its optimality.

On Demand Alternative Generation

The above alternative generation process 80 (FIG. 7) uses a recursive function to generate all T-choose-M possible legal alternatives, which satisfy all max rules, and store them to be processed in order of their scores. The time required to execute the process 80 is generally acceptable when expected M and T are relatively small, but may not scale up to the needs of some applications. In order to reduce computational effort, an “on-demand” approach (referred to as “ODAG” for “On Demand Alternative Generation”) is provided that generates the next best alternatives one at a time, on an as-needed basis. The ODAG approach stores the “state” information necessary to generate more alternatives later if needed. For situations where T and M are large, the ODAG algorithm is orders of magnitude faster than the previous process 80 because the ODAG algorithm scales with the complexity of the solution, rather than the size of the search space.

The alternatives generated can be pictured within an inverted tree structure. At the top is the root of the tree, which is the initial alternative. Whenever a node in the tree breaks a rule, child nodes are created corresponding to possible ways of fixing the broken rule. The alternative generation process 80 creates all of the immediate children of a node simultaneously. By contrast, the ODAG algorithm creates the children on an as-needed basis. Initially, ODAG creates the first child. If the first child breaks another rule, then along with creating its own first child (a grandchild of the original node), its next sibling is created if needed.

As described above with respect to FIG. 7, the algorithm 80 can be summarized according to the following pseudocode:

```
Generate best possible initial alternative.
For (all rules) {
    Check alternative against rule.
    If (not legal) {
        Store information about which rule was broken.
        Generate new alternatives recursively and store them in list
sorted by total scores.
        Begin “For loop” again with next best alternative.
    }
}
```

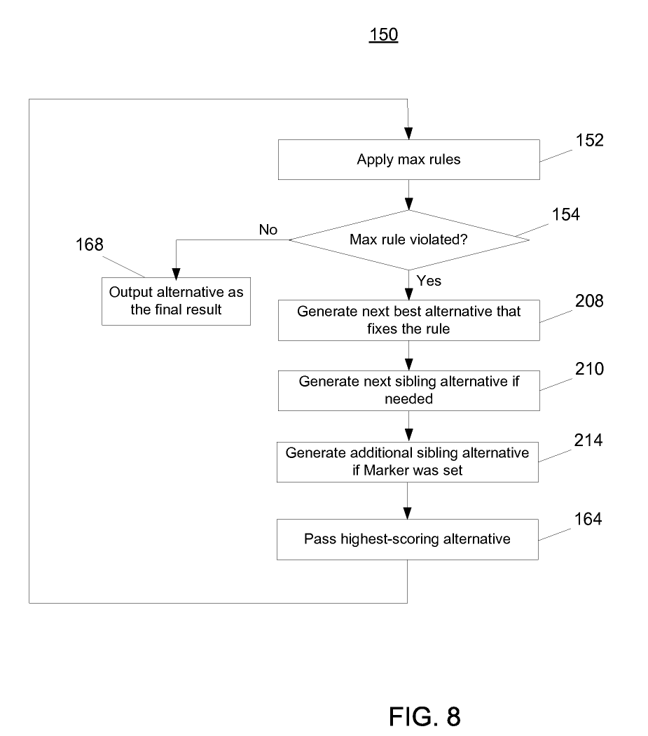

Referring to FIG. 8, the ODAG algorithm is shown in further detail and corresponds to the following pseudocode.

```
Generate best possible initial alternative.
For (all rules) {
    Check alternative against rule (152).
    If (not legal) (154) {
        Store information about which rule was broken.
        (A) Generate single next best child alternative that fixes the rule
    and store it in list sorted by total scores. (208)
        (B) Generate next best sibling alternative (if needed),  and
store it in list sorted by total scores. (210)
        (C) Generate next best sibling alternative (if needed) using
        marker (214), and store it in list sorted by total scores.
        Begin “For loop” again with next best alternative (164).
        }
    Else, output (168) alternative as a final result
    }
```

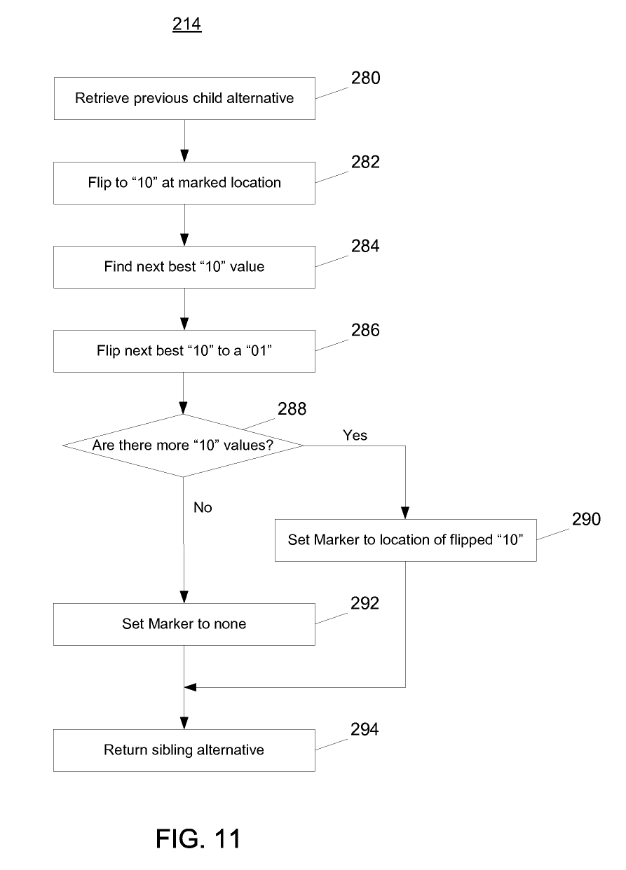

Actions (A)-(C) of the pseudocode are described in further detail below with respect to FIGS. 11-13, respectively. In some embodiments, the alternative generation process 80 (FIG. 7) of the contact optimization algorithm 60 shown in FIG. 4 is replaced with the ODAG algorithm 150 of FIG. 8.

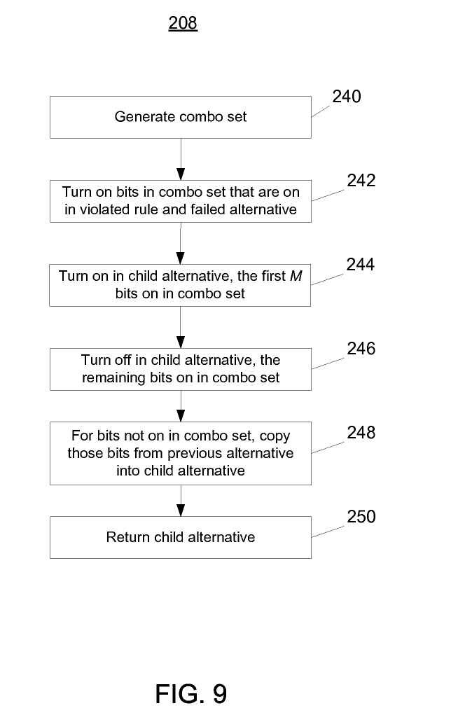

Referring to FIG. 9, the process 208 for generating the best child alternative using ODAG is described in further detail. The process 208 generates (240) a vector called a combo set whose bits correspond to the possible offers, turning on (242) those bits that correspond to both (1) the max rule that was violated and (2) the previous alternative that violated it. In other words, the process 208 performs an AND operation on the bits in the rule and the bits in the previous alternative. In the child alternative, bits are turned on corresponding to the first M bits that are on in the combo set (244), where M comes from the max(M,S) rule that was broken. The remaining bits that are on in the combo set (i.e., those that are not included in the first M bits) are turned off in the child alternative (246). The bits in the child alternative that correspond to bits that are off in the combo set are set (248) to be identical to the corresponding bits of the previous alternative. For example, if the last three bits of the combo set are “000” and the last three bits of the previous alternative are “101”, the last three bits of the child alternative would also be set to “101.” The parent for the new alternative is the old alternative, and the Marker (explained below) for the new alternative is set to “None.” When an alternative contains multiple “10” bit combinations that could be flipped to “01”, the ODAG algorithm 150 will flip them in descending score order. A Marker is used to keep track of the location of the last flip. When the next flip is to be tried, the Marker can be used to undo the previous flip and replace it with the next lowest scoring flip. So for example, if the algorithm finds the next lowest scoring sibling after “1010” to be “1001”, it marks the location of that flip, and when it is time to find the next lowest scoring sibling, it generates “0110” by undoing the last flip and replacing it with another flip. Markers are used in cases where multiple bits must be changed to generate the next lowest scoring sibling.

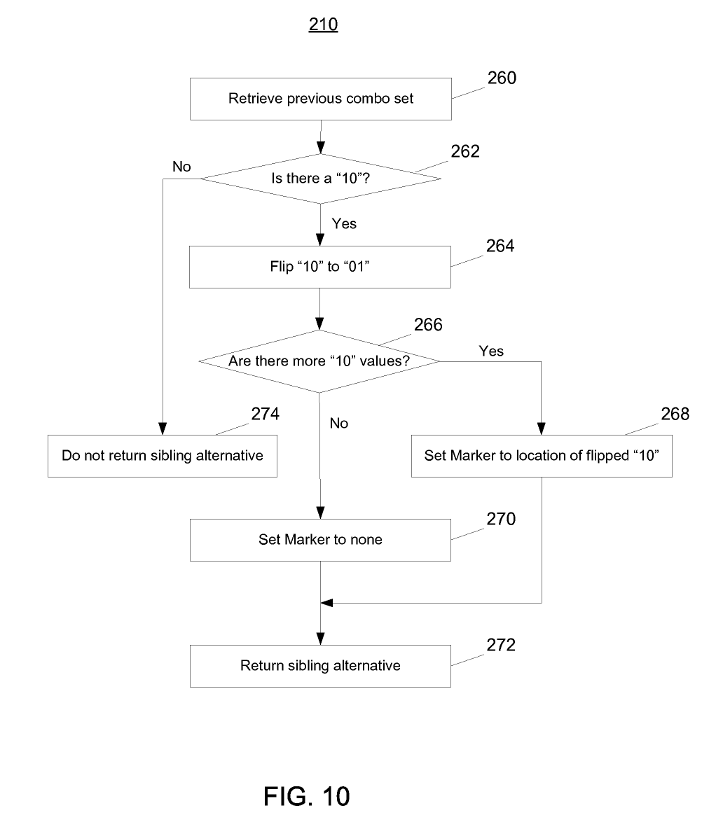

Referring to FIG. 10, the process 210 for generating the next best sibling alternative using ODAG is described in further detail. The process 210 retrieves (260) the previous combo set generated for the previous child alternative by process 208 of FIG. 9. Thus, the combo set for the new sibling alternative is the same as the old combo set that was generated for the previous child alternative. The process 210 determines (262) whether the previous child alternative bits that are on in the combo set includes a “10” that can be flipped to a “01.” If so, the process 210 creates a new sibling alternative that is identical to the previous child alternative except that it flips (264) a “10” from the previous child to a “01” in the new sibling. If there are multiple instances of “10” in the previous child corresponding to bits that are on in the combo set, the process 210 flips the instance that reduces the score by the least amount, i.e., the set that minimizes (score10-score01), where score10 represents the score of the previous child and score01 represents the score of the new sibling after a selected “10” value has been flipped to a “01.” If there are no “10” values to flip, the process 210 returns without generating a sibling (274). The parent for the new sibling alternative is the same as the parent for the child alternative from which the sibling alternative was derived. The process 210 determines (266) whether are any other, lower valued “10” values to flip. If there are other “10” values, the process 210 sets (268) the Marker for the new alternative to be the location of the “10” that was flipped; otherwise the Marker is set (270) at “None”. The resulting sibling alternative is returned (272).

Referring to FIG. 11, the process 214 for generating a second sibling alternative is described in further detail. The process 214 is invoked if it is determined (FIG. 8) that the Marker of the previously generated child alternative has been set. The process 214 retrieves (280) the previous child alternative that was generated. In generating the new alternative, the process 214 flips (282) the marked location (referenced by the Marker) back to “10” and finds (284) the next best “10” value in the previous child alternative corresponding to bits that are on in the combo set to flip, and flips (286) it to a “01” in the new alternative. The parent for the new alternative is the same parent of the previous alternative. The process 214 determines (288) whether there are other, lower valued “10” values to flip. If there are other “10” values, the process 214 sets (290) the Marker for the new alternative be the location of the “10” that was flipped; otherwise the Marker is set (292) at “None”. The resulting sibling alternative is returned (294).

The following examples illustrate the use of the ODAG algorithm 150 for generating alternatives with reference to each of steps (A)-(C).

### Example

Suppose there are 9 offers for a particular customer.

Rule 1: at most 5 offers per customer, i.e. Max(5, 111111111)

Rule 2: can't have offers 2 and 3 together, i.e. Max(1, 011000000)

Generate initial alternative (0) 111111111 with marker=“None”, parent=“None”.

Rule 1 violated. (A) generates alternative (1) 111110000 with combo set=111111111, marker=“None”, parent=0. (B) and (C) do nothing.

Current alternative (1)=111110000

Rule 2 violated.

(A) generates alternative (2) 110111000 with combo set=011000000, marker=“None”, parent=1.

(B) generates alternative (3) 111101000 with combo set=111111111, marker=“None”, parent=0.

(C) does nothing.

Current alternative (3)=111101000. Farther down on list is (2) since it must have a lower total score.

Rule 2 violated.

(A) generates alternative (4) 11010101100 with combo set=011000000, marker=“None”, parent=3.

(B) generates alternative (5) 111100100 with combo set=111111111, marker=5, parent=0.

(C) does nothing.

Current alternative (5)=111100100. Farther down on list are (2) and (4).

Rule 2 violated.

(A) generates alternative (6) 110100110 with combo set=011000000, marker=“None”, parent=5.

(B) generates alternative (7) 111100010 with combo set=111111111, marker=6, parent=0.

(C) generates alternative (8) 111011000 with combo set=111111111, marker=“None”, parent=0.

Eventually, this process ends when alternative (2) is popped from the list and passes all the rules.

The ODAG algorithm 150 does not need to explicitly allocate storage for the combo sets. The combo sets can be reconstructed based on two pieces of information that are already stored: the parent, and the rule violated. New storage is allocated for the marker array, and a flag array for keeping track of any duplicate alternatives (which do not run (A), only (B) and (C)).

Max Transaction Sets internal rules can be processed in much the same way as Max(M,S) rules except at a different level. In the Max Transaction Sets rules, along with the regular bit string at the transaction level (where each transaction is represented by a bit), there is another bit string being operated on in parallel, at the level of sets of transactions (where each transaction set is represented by a bit). The transaction sets must form a partition over the set of all transactions (i.e. each transaction must belong to exactly one transaction set). In this formulation, the bit for a transaction set is turned on if and only if at least one of the transactions in the set is on. The scores for each transaction set can be computed by adding together the scores of transactions within the set that are on. When a maximum number of transaction sets rule is broken by an alternative, the algorithms 80 and 150 can be applied to the higher level bit strings to determine which transaction sets should be turned off.

Subtraction Versus Addition (Min Rules)

As is apparent from the description thus far, the alternative generation algorithms 80 (FIG. 7) and 150 (FIG. 8) handle only max rules, and are therefore subtractive in nature (e.g., a max rule may be fixed by subtracting one or more offers from a set of offers to be considered). For example, the initial alternative assumes that all offers will be sent out as a default, unless some needed to be subtracted in order to obey a max rule.

As described above, min rules (denoted Min(M,S)) require at least M offers from a set S of offers to be sent to any customer. The min rules are additive in that offers from the set S of a violated min rule may be added to an alternative so that it passes the rule. Neither of the alternative generation algorithms 80 (FIG. 7) and 150 (FIG. 8) directly handle min rules since these algorithms are subtractive in nature. However, in some campaigns, when max rules might otherwise subtract important offers, there is a need for the capability to enforce min rules. For example, such a need can arise in cases where some offer(s) needed to be prioritized higher than their scores might otherwise mandate. There are various ways to modify the algorithms 80 and 150 to enforce min rules in addition to the max rules.

One technique of handling min rules is to modify algorithm 150 to simply reject any alternatives that break a min rule without producing any children of the illegal alternatives. This technique finds the optimal solution and executes relatively fast in cases where the min rules are met in high scoring alternatives. However, executing this technique would be extremely slow, i.e., impractically slow, in cases where the min rules are only met in low scoring alternatives and where there are a large number of alternatives. Unfortunately, these cases are the sort of situations where min rules would likely be used. For example, suppose a maximum of 13 out of 26 offers (A thru Z, where A is the most profitable and Z is the least profitable) are allowed and a minimum of 13 of offers (N thru Z) are required. By inspection, the solution would consist of N thru Z, but the method described above would take a long time to find this answer.

Another technique for enforcing min rules runs the ODAG algorithm 150 solely on offers within the min rule scope, with a max rule corresponding to the number of offers that are needed to fulfill the min rule. After those offers are locked in, the technique runs the ODAG algorithm 150 to select any additional offers that are compatible with the already selected offers. In short, this technique is a “greedy algorithm” in that it is optimal when it can optimize offers independently inside and outside the min rule scopes. However, it is not always the case that the technique is optimal.

For example, suppose that there are offers A thru C with scores of 995, 10, and 5, respectively. There is a max rule Max(2, ABC); a min rule Min(1, BC); and another max rule Max(1, AB), which really means “Not A with B.” The algorithm would first solve the problem of finding max 1 of BC, which is B. It would lock in B, and then see if any more offers from {A,C} could be selected. Because of the “Not A with B” max rule, only C would be added for a total score of 15. However, the optimal solution would be to select A and C for a much higher total score of 1000. A more integrated approach for enforcing min rules may improve the optimality of the result and improve computational efficiency.

Integrated Algorithm for Optimal Processing of FEC Min Rules

Described below is an algorithm that integrates that handling of FEC min rules with the handling of FEC max rules to efficiently generate optimal solutions. The algorithm is referred to as an “integrated mins algorithm.”

The integrated mins algorithm includes some features from the previously described ODAG algorithm 150 and new features to ensure that the alternatives that it returns obey all of the min rules, i.e., are “min-fulfilling.” Before the algorithm considers an alternative as a solution, the algorithm checks the alternative against all min rules. If the alternative passes, then the algorithm places the alternative on a list for consideration as a solution. If the alternative violates any of the min rules, the algorithm modifies the alternative (including deleting it completely). For example, if the alternative was generated from a “Not A with B” rule and there are no negative scoring bits that can be turned on to fulfill the broken mins, it is simply deleted without any children.

Alternatives that may pass Max(M,S) type rules (e.g. FEC max and max dups) but violate one or more min rules are handled by a sub-ODAG procedure. The sub-ODAG procedure modifies an illegal alternative to generate the next highest scoring alternative that passes all min rules. The algorithm iteratively applies max rules and min rules to alternatives, modifying the alternatives as needed, until it finds an alternative that satisfies both sets of min and max rules. Since the algorithm starts with the highest-scoring alternative and progressively determines the next highest-scoring alternatives, as soon as the algorithm finds an alternative that satisfies both the min and max rules, that alternative is the optimal solution. Thus the algorithm generally does not spend extra time considering any further alternatives after it finds an alternative that satisfies all of the rules.

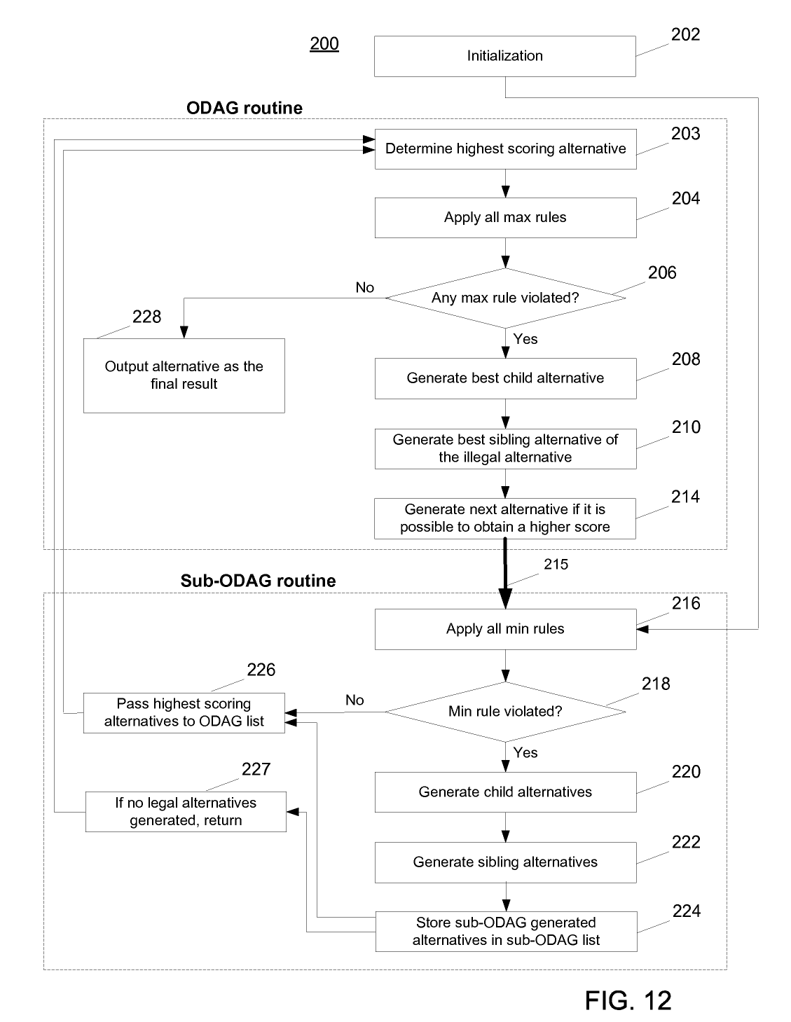

Referring to FIG. 12, an integrated mins algorithm 200 includes two routines: the ODAG routine and the sub-ODAG routine. As will be further described below, the ODAG routine determines whether an alternative violates a max rule and modifies it accordingly to generate new alternatives that pass the broken max rule. These alternatives may break other max rules. The ODAG routine keeps a list of sorted alternatives by score in descending order. Any alternative must have gone through the sub-ODAG routine and therefore be min-fulfilling before being added to the ODAG list. The algorithm 200 evaluates the top scoring alternative from the ODAG list and by iterating through all the max rules, the ODAG routine eventually finds an alternative that fulfills all the max rules, at which point the optimal solution has been found.

The sub-ODAG routine is called during initialization and each time ODAG generates a new alternative (e.g., when a max rule is violated). It determines whether an alternative violates one or more min rules. If any min rule is violated, sub-ODAG modifies the alternative to generate a new alternative that passes all of the min rules. The alternatives returned by the sub-ODAG routine to the ODAG routine are min-fulfilling. In other words, before the ODAG routine considers an alternative as an optimal solution, sub-ODAG will have checked the alternative against all min rules, and modified the alternative if any of the min rules were not satisfied.

The algorithm 200 performs an initialization process (202) that orders the max rules, denoted Max(m, s), by the most restrictive first. For example, the ordering may be accomplished by performing the following calculation:

$$\frac{{\sum }_{\{ i = 1 , m \}} [ ( s choose i ) ]}{{\sum }_{\{ i = 1 , s \}} [ ( s choose i ) ]} \qquad$$

and sorting the results in ascending order. The initialization process (202) initializes a list of alternatives to be considered as an optimal solution, referred to as an “ODAG list of alternatives,” to empty. The initialization process (202) also generates an initial alternative that has all offer bits with positive scores “on.” For example, an initial alternative of “1110” is generated for a campaign that includes exactly four possible offers, the first three of which have positive scores and the last one having a negative score. If all of the four possible offers have positive scores, the initial alternative is “1111”

Before the initial alternative is placed on the ODAG list of alternatives, it is passed to the sub-ODAG routine and modified, if necessary, so that it passes all of the min rules. Since all or most of the bits of the initial alternative are on, the initial alternative generally passes all of the min rules and is passed to the ODAG list of alternatives. All of the alternatives stored in the ODAG list have passed all of the min rules.

The algorithm 200 invokes the ODAG procedure, which determines (203) the highest scoring alternative on the ODAG list and applies (204) all max rules, one at a time and in order, to the top-scoring alternative on the ODAG list and determines (206) whether the alternative violates any of the max rules (206). If the alternative passes all of the max rules, it is the optimal solution and is output (228). If the alternative violates one or more of the max rules, the ODAG procedure generates (208) the best child alternative by modifying the illegal alternative in an attempt to pass the max rule that it violated. The process (208) for generating the best child alternative is described in further detail above with respect to FIG. 9.

The initial alternative may have multiple possible child alternatives; however, the best child alternative is the highest scoring child that passes the broken max rule. The ODAG procedure also generates (210) the best sibling alternative of the illegal alternative. The process (210) for generating the best sibling alternative is described in further detail above with respect to FIG. 10 with addition that no negative scoring “1” bits may be flipped.

The ODAG routine generates another sibling alternative (214) when it is possible for another combination of offers to have a higher total score than the generated sibling alternative (210). Any alternatives generated from 208, 210, or 214 are then passed (215) from the ODAG procedure to the sub-ODAG procedure.

The sub-ODAG routine applies (216) the min rules to each of the alternatives passed from the ODAG procedure and determines (218) whether any of the min rules have been violated. If the alternative passes all of the min rules, it is placed (226) on the ODAG list. If however, the alternative is found to violate a min rule, the sub-ODAG procedure modifies the alternative to generate (220) child alternatives that pass the broken min rule. The sub-ODAG procedure also generates (222) sibling alternatives that also fix min rules. As with other min rules handled by the integrated-mins algorithm, all alternatives on the ODAG list must pass all BOWA rules. Furthermore, if a proposed alternative fails a BOWA rule, the sub-ODAG routine will attempt to fix it by generating child alternatives (220) and sibling alternatives (222) if appropriate.

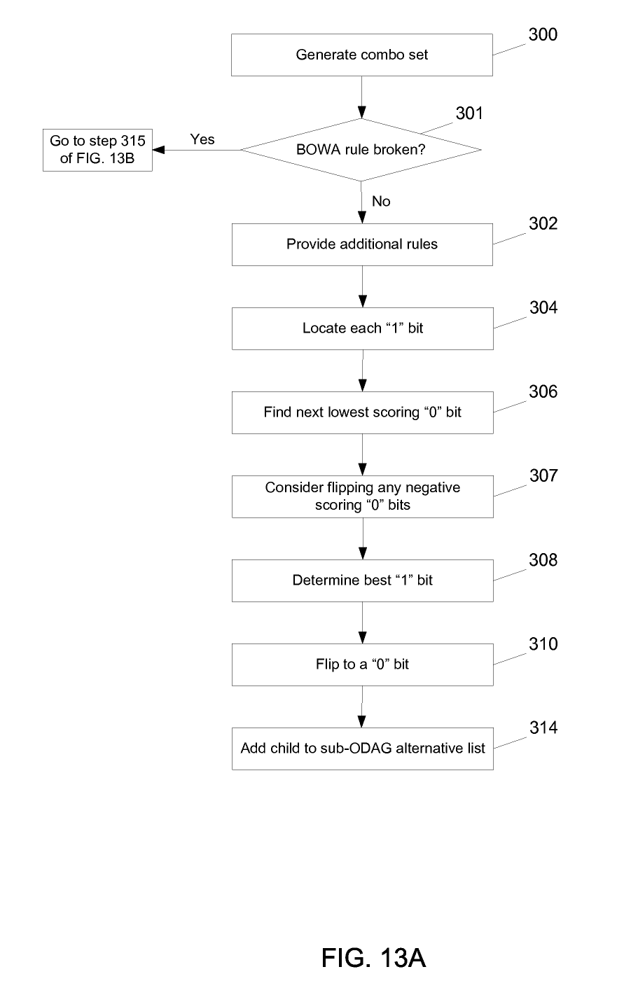

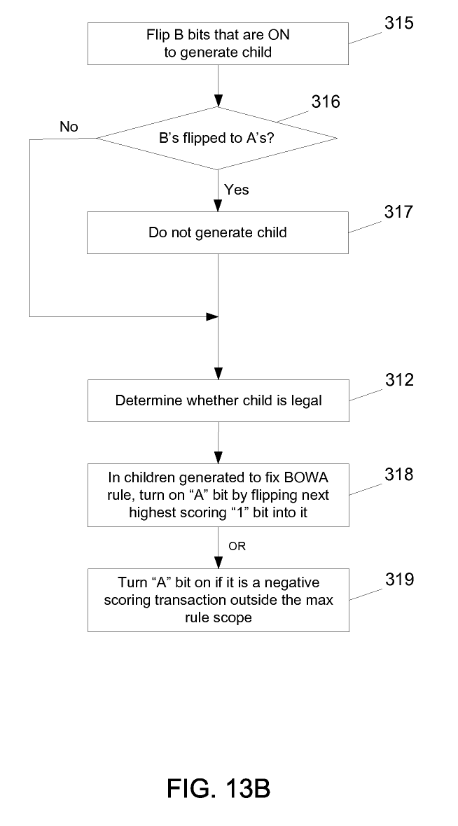

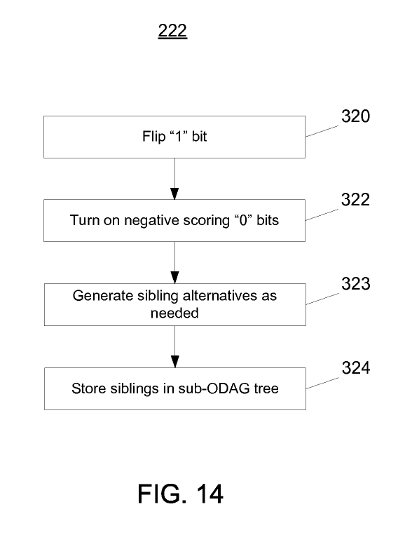

The processes (220) and (222) for generating child and sibling alternatives using sub-ODAG are described in further detail with respect to FIGS. 13 and 14, respectively. The alternatives generated by 220 and 222 are stored (224) in a separate sub-ODAG list, sorted in descending score order (any particular instantiation of sub-ODAG has a single list, but there may be multiple sub-ODAG's, each dealing with a single alternative proposed within ODAG that broke a min rule, and its siblings).

Alternatives are evaluated (highest scoring first) from this list until an alternative is found that passes all min rules and this highest scoring alternative from the sub-ODAG list is passed (226) to the ODAG list. The alternatives in the ODAG list are ordered according to their scores, with the highest being first.

If the process 200 determines (227) that the sub-ODAG alternative list is empty, i.e., no legal alternatives have been generated (including both the child alternative and its siblings), then no alternative is returned to the ODAG process.

The ODAG process is performed on the alternatives in the ODAG list in descending order. The ODAG and sub-ODAG processes are repeated until the ODAG process determines (206) a min-fulfilling alternative from the ODAG list that also passes all of the max rules. This alternative is output (228) as the final, optimal result. If the ODAG alternative list becomes empty, then there is no alternative that can fulfill all the rules and a message to that effect is sent to the log.

The high-level looping of the integrated mins algorithm 200 can be summarized as follows:
1. Initialization of first alternative; call sub-ODAG to pass all mins; put min-passing alternative on ODAG list
2. Test top alternative of ODAG list (the alternatives on this list always pass all mins) against each max rule in order. When one fails:
   Generate best child
   Generate best sibling
   Generate another sibling if Marker was set
3. Evaluate any alternatives generated by step #2 to see if any mins violated?
   If yes, call sub-ODAG; pass the top min-fulfilling alternative to the ODAG ordered list of alternatives
   If no, pass the alternative to the ODAG ordered list of alternatives
4. If top alternative of ODAG list passes all max rules, done (optimal solution found)

Referring to FIGS. 13A-B, the process 220 for generating child alternatives using sub-ODAG is described in further detail. The alternative that had violated (218, FIG. 12) the min rule (also referred to as an “illegal alternative”) is passed to the process 220 and placed on the top of the sub-alternative list. From the illegal alternative, the process 220 attempts to find the highest scoring child alternative that passes the broken min rule. A sub-ODAG tree is generated with the illegal alternative being the root of the tree. The nodes of the tree consist of child and sibling alternatives derived from the illegal alternative using the sub-ODAG process 220 and 222, which are further described below.

The process 220 begins by generating (300) a combo set that results from performing an AND operation between the bits of the max rule that was violated by the illegal alternative's parent and the bits of the parent alternative. The process 220 determines (301) whether the violated min rule is a BOWA (“B only with A”) rule. Broken BOWA's occur when one or more B's are ON with no A's ON. If the min rule is a BOWA rule, the process 220 proceeds to step 315 of FIG. 13B; otherwise the process 220 will attempt to find the next lowest scoring way to help to fix the broken min rule by considering each “1” bit in the illegal alternative that is also a “1” in the combo set, to select the best one to flip. The process provides (302) additional rules that govern how broken min rules may be repaired given three different scenarios concerning the “1” bits:
I. A “1” bit within the broken min rule scope is not a candidate for flipping.
II. A “1” bit within the scopes of other min rules that have no surplus bits on can only be flipped into the intersection of the other scopes and the broken scope, unless there is no intersection or no “0” bits in the intersection.
III. Those “1” bits that are only within the scopes of other min rules with surplus bits on can be flipped anywhere into the broken min rule scope.
IV. Also consider turning on negative scoring “0” bits anywhere in the broken min rule scope except within the broken max rule's scope.

The process 220 locates (304) each “1” bit in the current alternative that is also on in the combo set, and using the three rules above finds (306) the next lowest scoring “0” bit to flip it to. Different “1” bits may be flipped to different target “0” bits. The process also considers (307) turning on any negative scoring “0” bits anywhere in the broken min rule scope except within the scope of the max rule broken by the illegal alternative's parent. The process 220 determines (308) the best “1” bit to flip out of all of the “1” bits that were considered (i.e. least score-reducing), and flips (310) it with its corresponding target “0” bit (or turns on the least negative scoring “0” bit if that is the least score-reducing). The result is the first child alternative within sub-ODAG and it is added (314) to the sub-ODAG alternative list.

When the min rule broken is a BOWA rule, the sub-ODAG routine fixes broken BOWA's by generating up to 2 types of children in its sub-ODAG tree within the overall sub-ODAG scope (defined by an FEC max rule):

In one child, the sub-ODAG routine flips (315) all of the B bits that are ON to the next lowest scoring non-B bits or turns them off if there are none. However, if any of the bits that the B's are flipped into are A's (316), then the sub-ODAG routine does not generate this child (317) because it will be covered (with at least as high a score) by other children (siblings) generated in step 224 of FIG. 12. The process 220 determines (312) whether the child alternative is legal, and if so, it is stored (312) on an alternative list sorted in descending score order and also added to the sub-ODAG tree; otherwise it is excluded from the alternative list.

In the other children generated to fix a BOWA rule, a single A bit is turned on by flipping the next highest scoring “1” bit into it (318), or just turning it on if it is a negative scoring A transaction outside the max rule scope (319).

BOWA children of both types are generated as needed in decreasing score order.

Referring to FIG. 14, the process 222 for generating sibling alternatives within sub-ODAG is described in further detail. Siblings of the child alternative are generated by selecting another bit from the illegal (parent) alternative to flip instead. However, no siblings need be generated that flip to a target bit that has already been tried. For example, if flipping B to D and flipping C to D are both options, only the best of the two needs to be tried. The other sibling need not be generated, as it will lead to duplicates.

Along with finding “1” bits to flip (320), another way to fix min rules is to turn on negative scoring “0” bits that are in the scope of a broken min rule (322). These bits also compete with the flips described in rules I-III above, and they need not be within the combo bits to be set.

The process 222 generates (323) sibling alternatives in descending score order on an as needed basis. The siblings are stored (324) in the sub-ODAG alternative list. As was described in FIG. 12, if the min rules are all met, then sub-ODAG passes (226) the highest scoring passing alternative to the ODAG process. If this ODAG level alternative later fails a max rule (206), its ODAG child will be generated by the usual method (208) from broken max rules. The ODAG sibling alternatives are generated by re-entering the sub-ODAG instantiation that produced the alternative and searching for the next lowest scoring min-fulfilling alternative.

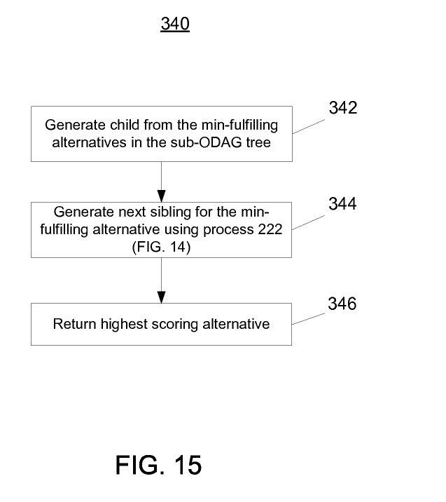

Referring to FIG. 15, a process 340 for generating ODAG sibling alternatives is described. First a child is generated (342) from the min-fulfilling alternative when the process flips “1” bits of the alternatives present in the sub-ODAG tree according to the following rules:
I. Within scopes of min rules that have no surplus bits on, a bit can only be flipped into intersection of those scopes, unless there is no intersection or no “0” bits in the intersection.
II. Otherwise, the bit can be flipped anywhere.
III. Also consider turning on negative scoring “0” bits anywhere in the broken min rule scope except within the broken max rule's scope.
   Second, the process 340 generates (344) the next sibling (if any) for the min-fulfilling alternative using the process 222 described in FIG. 14. Then, continue running sub-ODAG by popping the highest scoring alternative off of its list (346).

The communication between the ODAG process and the various sub-ODAG processes can be summarized as follows. Each proposed alternative within ODAG, before it is allowed to be placed on ODAG's alternative list, obeys all min rules. If it does not, and it is from a general Max(M,S) type rule, the non-min-fulfilling alternative becomes the root of a separate sub-ODAG tree. The sub-ODAG tree may contain alternatives that do or do not obey all min rules. After the sub-ODAG process passes (226) a min-fulfilling alternative to the ODAG process, that alternative takes the place of the non-min-fulfilling alternative that prompted the call to sub-ODAG in the first place. The sub-ODAG process remains dormant while the ODAG process checks alternatives against max rules, even though there may still be other alternatives in the sub-ODAG tree that have not been considered.

If a sibling within the ODAG process needs to be generated for a min-fulfilling alternative that was produced by a sub-ODAG process, the dormant sub-ODAG process is revived, with the min-fulfilling alternative forced to generate a new offspring within sub-ODAG, which competes with any other alternatives that were left on that sub-ODAG's alternative list. The min-fulfilling alternative passed by the sub-ODAG process to the ODAG is the sibling whose need for production prompted the re-entry into the sub-ODAG process. If, however, the sub-ODAG is unable to generate a min-fulfilling alternative (i.e., there are no alternatives left on the sub-ODAG alternative list to pass), it returns failure, and the proposed alternative (e.g., sibling) within ODAG that prompted the call to sub-ODAG is deleted without any offspring.

Examples 1a-b are simple examples that illustrate why min scope intersections are important in finding a correct solution. In examples 1a-b, the following rules are applied to determine an optimal set of offers from available offers A thru D: an FEC max rule of 2 of offers A thru D; an FEC min of 1 of B and D; an FEC min of 1 of C and D. Examples 1a and 1b differ only in their scores, but the integrated mins algorithm is able to find the optimal solution in both cases.

### Example 1a

The following chart illustrates the rules graphically. Scores of 100, 30, 20, and 10 are assigned to offers A thru D, respectively.

| | A | B | C | D |
|---|---|---|---|---|
| FEC MAX 2 | 1 | 1 | 1 | 1 |
| FEC MIN 1 | 0 | 1 | 0 | 1 |
| FEC MIN 1 | 0 | 0 | 1 | 1 |
| Scores | 100 | 30 | 20 | 10 |

The initial alternative, which includes all of the offers, is ABCD (1) and has a score 160. The initial alternative is fed to the ODAG process where it is found to violate the FEC max rule. A first child alternative, AB (2), having a score of 130 is proposed, but the first child violates CD min rule. As a result, AB is not selected as a first child by the ODAG process, and instead, the sub-ODAG process is called into action. The root of the sub-ODAG tree is AB. As AB violates the CD min rule, the algorithm analyzes the “1” bits (which correspond to A and B) to determine which to flip and where. To satisfy the CD min rule, the target choices are C and D. A can be flipped anywhere. Flipping A to C would have the least score loss (80). B can only be flipped to D. Flipping B to D would have a score loss of only 20. Therefore, B is flipped to D, yielding AD, which is passed back up to the ODAG process and is added to the ODAG alternative list. The actual “first child” is AD (3) score 110. AD passes all the rules, and is immediately correctly declared the optimal solution.

### Example 1b

The rules are the same those in the previous example; however, the scores assigned to the offers have changed. Offers A-D are assigned scores of 35, 30, 20, 10, respectively.

| | A | B | C | D |
|---|---|---|---|---|
| FEC MAX 2 | 1 | 1 | 1 | 1 |
| FEC MIN 1 | 0 | 1 | 0 | 1 |
| FEC MIN 1 | 0 | 0 | 1 | 1 |
| Scores | 35 | 30 | 20 | 10 |

The integrated mins algorithm generates an initial alternative of ABCD (1), which has a score of 95. The ODAG process determines that the initial alternative violates the FEC max rule and proposes a first child of AB (2), having a score of 65, to fix the rule. However, AB violates the CD min rule. As a result, AB is not selected as a first child by the ODAG process, and instead, the sub-ODAG process is called into action. The root of the sub-ODAG tree is AB. As AB violates the CD min rule, the algorithm analyzes the “1” bits (which correspond to A and B) to determine which to flip and where. To satisfy the CD min rule, the target choices are C and D. A can be flipped anywhere, but B can only be flipped to D. Flipping A to C would have the least score loss of 15. Flipping B to D would have a score loss of 20. Therefore, A is flipped to C, yielding BC, which is passed back up to the ODAG process and is added to the ODAG alternative list. So the actual “first child” of the ODAG process is BC (3), which has a score of 50. BC passes all the rules, and is immediately correctly declared the optimal solution.

### Example 2a

Referring to FIGS. 17A-H, Example 2a demonstrates what happens if the sub-ODAG process returns a min-fulfilling solution that breaks some other max-type rule, and sub-ODAG has to be re-entered to generate the next-best solutions. As shown in the table below, offers A thru H have scores 128, 64, 32, 16, 8, 4, 2, 1 respectively. The following rules, labeled M1, M2, M3, m4, and m5 apply:

M1. Max(3, ABCDEFGH) is an FEC max rule specifying that at most 3 offers may be selected from offers A thru H;

M2. Max(1, AB) is an FEC max rule specifying that offer A can never be with offer B.

M3. Max(1, AC) is an FEC max rule specifying that offer A can never be with offer C.

m4. Min[1, AE] is an FEC min rule specifying that at least one of offers A and E must be included.

m5. Min[1, DG] is an FEC min rule specifying that at least one of offers D and G must be included.

| | A | B | C | D | E | F | G | H |
|---|---|---|---|---|---|---|---|---|
| M1. (3, ABCDEFGH) - FEC | 1 | 1 | 1 | 1 | 1 | 1 | 1 | 1 |
| MAX 3 | | | | | | | | |
| M2. (1, AB) - NEVER A | 1 | 1 | 0 | 0 | 0 | 0 | 0 | 0 |
| WITH B | | | | | | | | |
| M3. (1, AC) - NEVER A | 1 | 0 | 1 | 0 | 0 | 0 | 0 | 0 |
| WITH C | | | | | | | | |
| m4. [1, AE] - FEC MIN 1 | 1 | 0 | 0 | 0 | 1 | 0 | 0 | 0 |
| m5. [1, DG] - FEC MIN 1 | 0 | 0 | 0 | 1 | 0 | 0 | 1 | 0 |
| SCORES | 128 | 64 | 32 | 16 | 8 | 4 | 2 | 1 |

In FIGS. 17A-H, the alternatives produced by the sub-ODAG process are enclosed in a dashed box and identified with a “(TN)”, where “T” stands for “top-down,” indicating that the alternative was generated to fix a violated max rule, and N is a number. Alternatives produced by the ODAG process are not enclosed and are identified by a “(BN),” where “B” stands for “bottom-up,” indicating that the alternative was generated to fix a violated min rule, and N is a number. The numbers N encode the order in which the alternatives are generated. A solid-lined box enclosing an alternative is used to denote that an alternative is added to the ODAG list, and an ellipse enclosing one or more alternatives signifies that those alternatives are the child and/or sibling alternatives produced by either the ODAG or sub-ODAG processes.

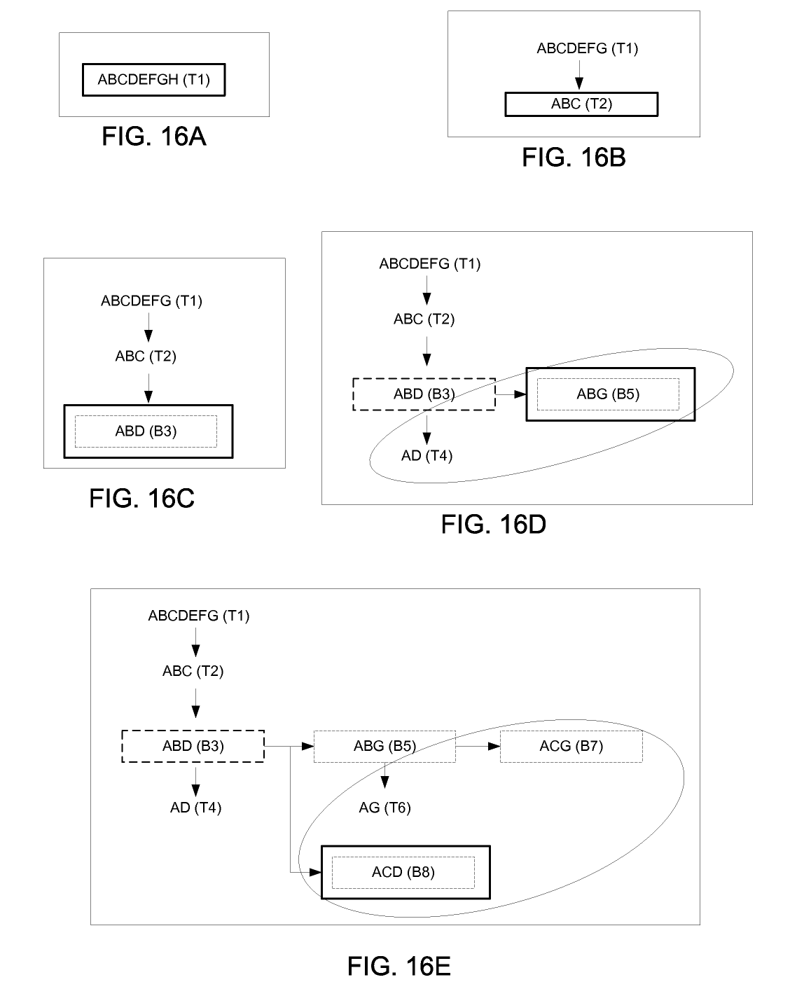

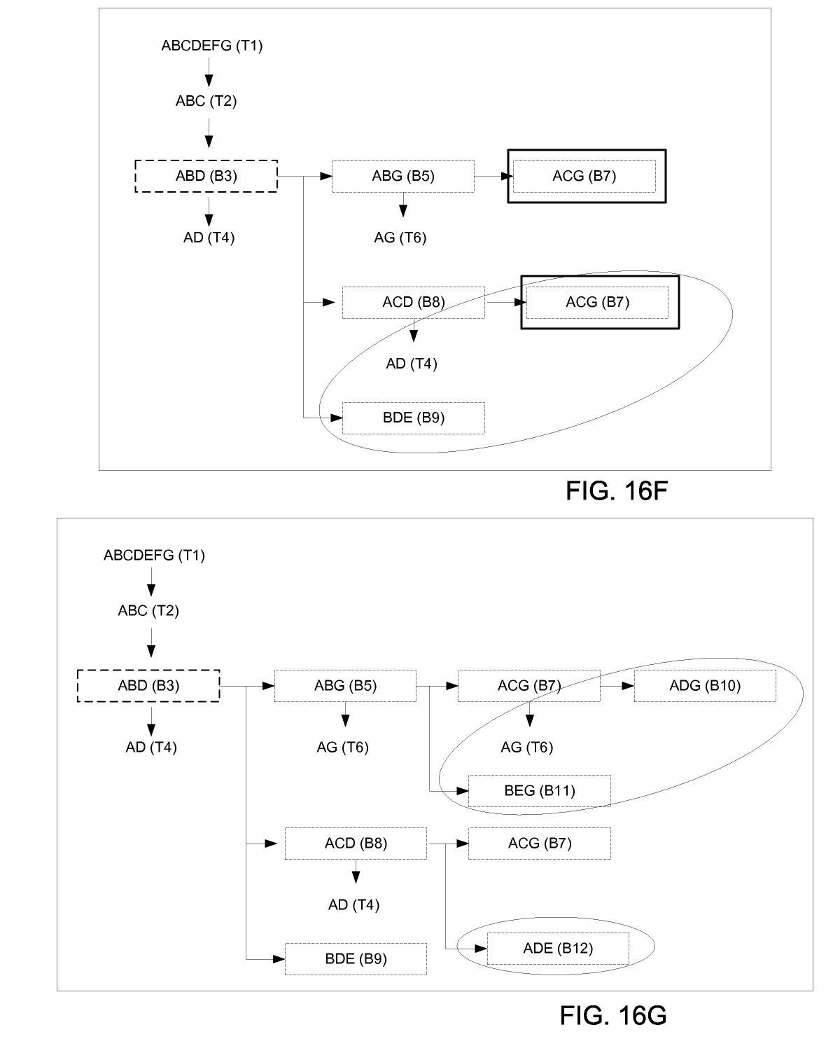

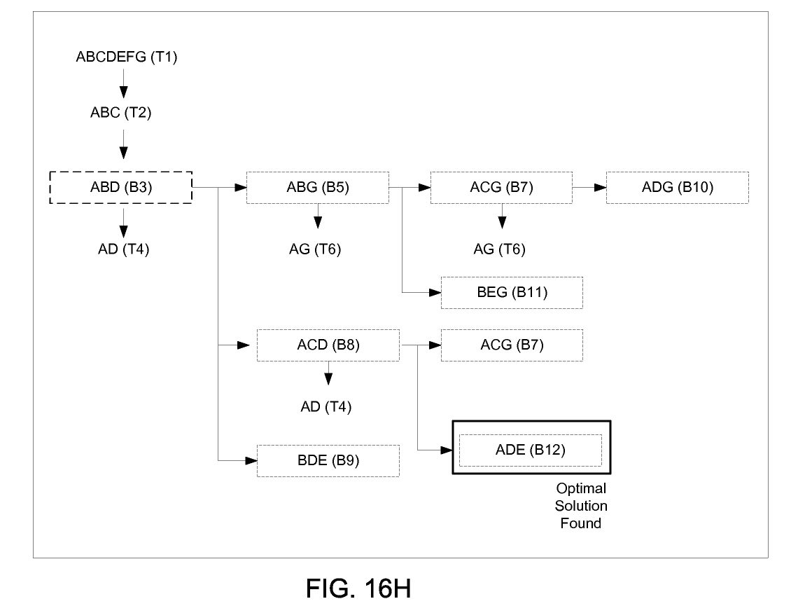

Referring to FIG. 16A, an initial alternative of ABCDEFGH (T1), having a score of 255, is produced from the initialization process (step 202 of FIG. 12). It passes all of the min rules m4 and m5 (sub-ODAG routine), but violates the max rule M1 (steps 204 and 206 of FIG. 12).

Referring to FIG. 16B, a first child of ABC (T2), with a score of 224, is proposed (step 208 of FIG. 12); however, ABC violates the DG min rule (m5) (steps 216 and 218 of FIG. 12), and the sub-ODAG routine is called into action.

Referring to FIG. 16C, the root of the sub-ODAG tree is ABC. Since ABC violates the DG min rule, the algorithm analyzes the “1” bits (ABC) to determine which to flip to produce a child that passes the rule. Flipping A to D would have score loss of 112. Flipping B to D would have score loss of 48. Flipping C to D would have score loss of 16. Therefore, C is flipped to D, yielding ABD (B3), with a score of 208, as first sub-ODAG child of ABC (T2) (step 220 of FIG. 12). ABD passes all of the min rules so it is popped off of sub-ODAG's alternative list and passed back up to regular ODAG as first child of ABCDEFGH (T1) (steps 224 and 226 of FIG. 12).

Referring to FIG. 16D, ABD is popped off of ODAG's alternative list (step 203 of FIG. 12) and evaluated with respect to the max rules M1, M2, and M3 (step 204 of FIG. 12). ABD is found to violate M2 “Not A with B” (step 206 of FIG. 12), so the algorithm generates AD (T4), with score 144, as a first child, and BD, with score 80, as a second child of ABD (B3) and sibling of the first child to fix the broken M2 max rule (steps 208 and 210 of FIG. 12). BD fails the AE min rule (m4) and is deleted without offspring (steps 216 and 218 of FIG. 12).

The algorithm generates the next sibling of ABD (B3) with the sub-ODAG routine (step 220 of FIG. 12). First sub-ODAG tries to generate a child for ABD. The bit corresponding to A can be flipped only to E, with score loss of 120; B can be flipped to C, with score loss of 32; and D can be flipped to G, with score loss of 14. Therefore D is flipped to G, yielding ABG (B5), with a score 194, as the first sub-ODAG child of ABD (B3) (step 222 of FIG. 12).

There are no sub-ODAG siblings of ABD (B3) since the algorithm has already tried flipping to the target bit D. ABG does not violate any min rules, so it is popped off of sub-ODAG's alternative list and passed back to the ODAG routine as the second child of ABCDEFGH (T1) (steps 224 and 226 of FIG. 12).

Referring to FIG. 16E, ABG is popped off of the ODAG alternative list (step 203 of FIG. 12) and evaluated with respect to the max rules M1, M2, and M3. ABG is found to violate M2 “Not A with B”, so the algorithm generates AG (T6), with a score of 130, as a first child, and BG, with a score of 66, as a second child of ABG (B5) (steps 208 and 210 of FIG. 12).

BG fails the AE min rule (m4) and is deleted without offspring (steps 216 and 218 of FIG. 12). The algorithm generates the next sibling of ABG (B5) with the sub-ODAG routine (step 220 of FIG. 12). First sub-ODAG tries to generate a child for ABG (B5). The bit corresponding to A can be flipped only to E, with score loss of 120; B can be flipped to C, with score loss of 32; and G cannot be flipped. Therefore, B is flipped to C, yielding ACG (B7), with a score of 162 as a first sub-ODAG child of ABG (B5) (step 222 of FIG. 12).

The algorithm also generates the sub-ODAG sibling of ABG (B5) (step 222 of FIG. 12). Since the algorithm already flipped D to G, it flips B to C, yielding ACD (B8), with a score of 176, as the second sub-ODAG child of ABD (B3). ACD does not violate any min rules, so it is popped off of sub-ODAG's alternative list and passed back to the ODAG routine as the third child of ABCDEFGH (T1) (steps 224 and 226 of FIG. 12).

Referring to FIG. 16F, ACD is popped off of the ODAG alternative list (step 203 of FIG. 12) and evaluated with respect to the max rules M1, M2, and M3. ACD is found to violate M3 “Not A with C”, so the algorithm generates AD (T4), with a score of 144, as the first child [and duplicate of the child of ABD (B3)], and CD, with a score of 48, as the second child of ACD (B8) (steps 208 and 210 of FIG. 12). CD fails the AE min rule (m4) and is deleted without offspring (steps 216 and 218 of FIG. 12).

The algorithm also generates the next sibling of ACD (B8) with the sub-ODAG routine (step 220 of FIG. 12). First sub-ODAG tries to generate a child for ACD (B8). The bit corresponding to A can be flipped only to E, with score loss of 120; C can be flipped to E, with score loss of 24; and D can be flipped to G, with score loss of 14. Therefore, D is flipped to G, yielding ACG (B7), with a score of 162, as the first sub-ODAG child of ACD (B8) [and duplicate of the child of ABG (B5)] (step 222 of FIG. 12).

The algorithm also generates the sub-ODAG sibling of ACD (B8) (step 222 of FIG. 12). Since the algorithm already flipped D to G and B to C, it flips A to E, yielding BDE (B9), with a score of 88, as the third sub-ODAG child of ABD (B3). ACG does not violate any min rules, so it is popped off of sub-ODAG's alternative list and passed back to the ODAG routine as the fourth child of ABCDEFGH (T1) (steps 224 and 226 of FIG. 12).

Referring to FIG. 16G, ACG is popped off of ODAG's alternative list (step 203 of FIG. 12) and evaluated with respect to the max rules M1, M2, and M3. ACG is found to violate M3 “Not A with C”, so the algorithm generates AG (T6), with a score of 130, as the first child (and duplicate of the child of AG (B5)), and CG, with a score of 34, as the second child of ACG (B7) (steps 208 and 210 of FIG. 12). CG fails the AE min rules (m4) and is deleted without offspring (steps 216 and 218 of FIG. 12).

The algorithm generates the next sibling of ACG (B7) with the sub-ODAG routine (220 of FIG. 12). First sub-ODAG tries to generate a child for ACG (B7). The bit corresponding to A can be flipped only to E, with score loss of 120; C can be flipped to D, with score loss of 16; and G cannot be flipped. Therefore, C is flipped to D, yielding ADG (B10), with a score of 146, as the first sub-ODAG child of ACG (B7) (222 of FIG. 12).

The algorithm generates the sub-ODAG sibling of ACG (B7) (step 222 of FIG. 12). Since the algorithm already flipped B to C, it flips A to E, yielding BEG (B11), with a score of 74, as the second sub-ODAG child of ABG (B5).

The algorithm generates another sub-ODAG sibling of ACG (B7) (222 of FIG. 12). Since D was already flipped G, the algorithm flips C to E, yielding ADE (B12), with a score of 152, as the second sub-ODAG child of ACD (B8).

Referring to FIG. 16H, ADE does not violate any min rules, so it is popped off of sub-ODAG's alternative list and passed back to the ODAG routine as the fifth child of ABCDEFGH (T1) (steps 224 and 226 of FIG. 12). It passes all max rules (steps 204 and 206 of FIG. 12) and is thus output as the optimal solution (step 228 of FIG. 12).

The algorithm applied in the previous example may be made more efficient by processing the max rules M2 “Not A with B” and M3 “Not A with C” first. In Example 2a, the max rule M1 (3, ABCDEFGH) was processed first. The following example illustrates how the algorithm is more efficient in the treatment below, with “Not A with B” rules processed first. With this ordering, the algorithm does not call on the sub-ODAG routine.

### Example 2b

As in Example 2a, the initial alternative of ABCDEFGH (1), with a score of 255, is generated during the initialization process (step 202 of FIG. 12). It passes all of the min rules m4 and m5 (sub-ODAG routine), but violates the max rule M2 “Not A with B” (steps 204 and 206 of FIG. 12). The ODAG process generates a first child ACDEFGH (2), with a score of 191, and a second child BCDEFGH (3), with a score of 127, to fix the broken M2 max rule (steps 208 and 210 of FIG. 12). ACDEFGH is popped off of ODAG's alternative list, as it is the highest scoring alternative on the list, and passed to the sub-ODAG routine.

ACDEFGH is found to violate max rule M3 “Not A with C”. The ODAG process generates ADEFGH (4), with a score of 159 as the first child, and CDEFGH (5), with a score of 63, as the second child of ACDEFGH (2) (steps 208 and 210 of FIG. 12). ADEFGH violates the max rule M1, so the ODAG process generates the next highest scoring child to pass the violated rule. This child is ADE (6) and has a score of 152. It passes all of the min rules as well as all of the max rules; therefore, it is the optimal solution. This example clearly demonstrates that applying the max rules in order of most restrictive to least restrictive can dramatically increase the efficiency of the integrated mins algorithm.

Other examples, e.g., examples 7a-b, et seq. illustrating the application of the integrated mins algorithm 200 of FIG. 12 are discussed below.

### Example 3

Transactions of offers A, B, C, D have scores of 27, 25, 20, −1, respectively, with D having a negative score. The following rules, M1, m2, and m3, apply:

M1: max 2 of ABC

m2: min of BD

m3: min of C

An initial alternative of 1110 is generated by the algorithm. The last bit, which corresponds to D, is turned off since D has a negative value. The initial alternative passes all of the min rules, but breaks the max rule (M1). To fix the broken max rule, the ODAG routine generates a child alternative of 1100. However, the child alternative breaks min rule (m3); and the sub-ODAG routine is called.

The bit of child alternative 1100 that corresponds to B is flipped into C, yielding the alternative 1010, which fails min rule [1, BD] (m2), and the sub-ODAG procedure fixes that broken rule by turning on the bit corresponding to D, as this change causes the smallest decrease in score. The final result is 1011, with a total score of 46.

### Example 4

Transactions of offers A, B, C, D have scores 100, 90, 80, 70, respectively. The following rules, M1, m2, and m3, apply:

M1: max 2 of ABCD

m2: min 1 of AC

m3: min 1 of BC

m4: min of D

An initial alternative of 1111 is generated by the algorithm. The initial alternative passes all of the min rules, but breaks the max rule (M1). To fix the broken max rule, the ODAG routine generates a child alternative of 1100. However, the child alternative breaks min rule “1 of D” (m4); and the sub-ODAG routine is called. The bit of child alternative 1100 that corresponds to B is flipped into D, yielding alternative 1001. This alternative fails min [1, BC] (m3). In correcting the broken rule, A is flipped into C, yielding the final result of 0011, with a total score of 150.

Handling BOWA Rules

The sub-ODAG portion of the integrated mins algorithm of FIG. 12 can also handle “B only with A” rules or “BOWA” rules, which, as described above, are classified as min-type rules. As with other min rules handled by the integrated-mins algorithm, all alternatives on the ODAG list must pass all BOWA rules. Furthermore, if a proposed alternative fails a BOWA rule, the sub-ODAG routine will attempt to fix it by generating child alternatives (step 220 of FIG. 12) and sibling alternatives (step 222 of FIG. 12) if appropriate.

As described above, with respect to FIGS. 15 and 16, the sub-ODAG routine repairs broken BOWA rules by proposing up to 2 types of children in its sub-ODAG tree within the overall sub-ODAG scope (defined by an FEC max rule). This procedure may be summarized as follows:

(1) In one child, all of the B bits that are ON are flipped to the next lowest scoring non-B bits (or turned off if there are none). However, if any of the bits that the B's are flipped into are A's, then this child is not generated because it will be covered (with at least as high a score) by (2) below.

(2) In the other children (i.e., siblings), a single A bit is turned ON by flipping the next highest scoring “1” bit into it, or just turning it ON if it is a negative scoring A transaction outside the max scope. The proposed children of types (1) and (2) are generated as needed in decreasing score order.

The following examples illustrate, more specifically, the application of BOWA rules by the integrated mins algorithm.

### Example 5a

Transactions of offers A, B, C, D have scores 100, 20, 10, and 5, respectively. The following rules M1 and m2 apply, where m2 is a BOWA rule:

M1: FEC max 2 of ABCD.

m2: A only with D.

An initial Alternative of 1111 is generated by the algorithm. The initial alternative passes all of the min rules, but breaks the max rule (M1). To fix the broken max rule, the ODAG routine generates a child alternative of 1100. However, the child alternative breaks BOWA rule (m2); and the sub-ODAG routine is called. The root of the sub-ODAG tree is 1100. To fix the broken BOWA rule, the sub-ODAG routine proposes a first child alternative of 0110, with a score 30, and a second child alternative of 1001, with a score of 105. The highest scoring proposed child (1001) becomes the first child and is returned to ODAG Since it passes the max rule (M1) it is the optimal solution.

### Example 5b

The rules are the same as those in Example 5a; however, the transactions of offers A, B, C, D have different scores of 100, 90, 50, and 10, respectively.

In this example, the children proposed by the sub-ODAG routine have different scores. The proposed child of 0110 has a score of 140, and the proposed child of 1001 has a score of 110. The highest scoring proposed child (0110) becomes the first child and is returned to ODAG. Since it passes the max rule (M1) it is the optimal solution.

### Example 6

Transactions of offers A, B, C, D, E have scores 100, 90, 50, 20, −10, respectively, with E having a negative score. The following rules, M1, m2, m3, m4, and m5, apply:

M1; FEC max 3 of ABCDE

m2: FEC min 1 of BC

m3: B only with E

m4: A only with C

A proposed initial alternative of 11110 is generated. The last bit, which corresponds to E, is turned off since E has a negative value. The proposed initial alternative breaks min rule 3 “B only with E”; sub-ODAG is called. The root of the sub-ODAG tree is 11110. To fix the broken BOWA rule, the sub-ODAG routine proposes the child 11111, where E is turned on, with a score of 250, and it also proposes the child 10110, where B is turned off (not flipped to E which is outside the combo bits), with a score of 170. Since 11111 is the highest scoring, and it passes all of the min rules, it is returned and becomes ODAG's initial alternative. It breaks the max rule M1. Since negative scoring bits cannot be turned off by ODAG, the proposed first child is 11001. This alternative fails the BOWA rule m4; another instantiation of sub-ODAG is called. Only one child is created to fix the BOWA rule: 10101, with score of 140. It passes all of the min rules and is returned to ODAG as the first child of 11111. Next, the sibling for 11111 is generated, by re-entering the first sub-ODAG instantiation. The second child 10110 with score 170 passes all of the min rules and is returned to ODAG. It is the highest scoring alternative on ODAG's list and passes all rules, and is correctly returned as the optimal solution.

### Further Examples

The following examples are provided to further illustrate the operation of the integrated mins algorithm as shown in FIG. 12.

### Example 7a

As shown in the chart below, offers A thru H have scores 128, 64, 32, 16, 8, 4, 2, 1, respectively. There is an FEC max rule of 4 for offers A thru H, and FEC min rule of 1 for BEGH; an FEC min rule of 2 for CEFH; and an FEC min rule of 2 for DFGH.

| | A | B | C | D | E | F | G | H |
|---|---|---|---|---|---|---|---|---|
| FEC MAX 4 | 1 | 1 | 1 | 1 | 1 | 1 | 1 | 1 |
| FEC MIN 1 | 0 | 1 | 0 | 0 | 1 | 0 | 1 | 1 |
| FEC MIN 2 | 0 | 0 | 1 | 0 | 1 | 1 | 0 | 1 |
| FEC MIN 2 | 0 | 0 | 0 | 1 | 0 | 1 | 0 | 1 |
| Scores | 128 | 64 | 32 | 16 | 8 | 4 | 2 | 1 |

An initial alternative of ABCDEFGHI (1), which has a score of 255, is generated by the integrated mins algorithm. The ODAG process determines that the initial alternative violates the FEC max rule and proposes a first child of ABCD (2), with a score of 240, to fix the violated max rule. However, ABCD violates the CEFH min rule. As a result, ABCD is not selected as a first child by the ODAG process, and instead, the sub-ODAG process is called into action. The root of the sub-ODAG tree is ABCD. As ABCD violates the CEFH min rule, the algorithm analyzes the “1” bits of the first child (which correspond to ABCD) to determine which to flip and where. To satisfy the CEFH min rule, the target choices are EFH. Flipping A to E would have score loss of 120. B can be flipped only to (BEGH ∩ CEFH)=EH, where “∩” represents the intersection of two sets. Flipping B to E would have score loss of 56. C cannot be flipped. D can be flipped only to (DFGH ∩ CEFH)=FH. Flipping D to F would have score loss of 12.

Therefore, D is flipped to F, yielding ABCF (3) with a score of 228. ABCF serves as the first sub-ODAG child of ABCD (2). ABCF is popped off of sub-ODAG's alternative list. ABCF, however, violates the DFGH min rule, so the sub-ODAG process determines which bits of ABCF to flip to fix the violated rule. The target choices are DGH. Flipping A to D would have score loss of 112. B can be flipped only to (BEGH ∩ DFGH)=GH. Flipping B to G would have score loss of 62. C can be flipped only to (CEFH ∩ DFGH)=H. Flipping C to H would have score loss of 31. F cannot be flipped. Therefore, C is flipped to H, yielding ABFH (4), with a score 197, as the first sub-ODAG child of ABCF (3).

The integrated mins algorithm also generates the next sibling of ABCF (3). ABCF was generated by flipping D to F. To get its next sibling, the algorithm goes back and performs the next best flip. Therefore, B is flipped to E, yielding ACDE (5), with a score of 184, as second sub-ODAG child of ABCD (2). ABFH, with a score of 197, is popped off of sub-ODAG's alternative list. It passes all the min rules, and is passed back to the ODAG process, where it is determined to pass all of the max rules. Therefore, ABFH is returned as the optimal solution.

### Example 7b

The same rules of Example 7a apply; however, the offers A thru H are assigned a different set of scores: 128, 127, 125, 121, 113, 97, 65, 1,respectively.

| | A | B | C | D | E | F | G | H |
|---|---|---|---|---|---|---|---|---|
| FEC MAX 4 | 1 | 1 | 1 | 1 | 1 | 1 | 1 | 1 |
| FEC MIN 1 | 0 | 1 | 0 | 0 | 1 | 0 | 1 | 1 |
| FEC MIN 2 | 0 | 0 | 1 | 0 | 1 | 1 | 0 | 1 |
| FEC MIN 2 | 0 | 0 | 0 | 1 | 0 | 1 | 0 | 1 |
| Scores | 128 | 127 | 125 | 121 | 113 | 97 | 65 | 1 |

The integrated mins algorithm generates an initial alternative of ABCDEFGHI (1), which has a score of 777. The ODAG process determines that the initial alternative violates the FEC max rule and proposes a first child of ABCD (2), with a score of 501, to fix the violated max rule. However, ABCD violates the CEFH min rule. As a result, ABCD is not selected as a first child by the ODAG process, and instead, the sub-ODAG process is called into action. The root of the sub-ODAG tree is ABCD. As ABCD violates the CEFH min rule, the algorithm analyzes the “1” bits of the first child (which correspond to ABCD) to determine which to flip and where. To satisfy the CEFH min rule, the target choices are EFH. Flipping A to E would have score loss of 120. B can be flipped only to (BEGH ∩ CEFH)=EH. Flipping B to E would have score loss of 14. C cannot be flipped. D can be flipped only to (DFGH ∩ CEFH)=FH. Flipping D to F would have score loss of 24.

Therefore B is flipped to E, yielding ACDE (3) Score 487 as first sub-ODAG child of ABCD (2). ACDE is popped off of sub-ODAG's alternative list. ACDE, however, violates the DFGH min rule, so the sub-ODAG process determines which bits of ACDE to flip to fix the violated rule. The target choices are FGH. A can be flipped anywhere. Flipping A to F would have score loss of 31. C can be flipped only to (CEFH ∩ DFGH)=FH. Flipping C to F would have score loss of 28. D cannot be flipped. E can be flipped only to ((BEGH ∩ CEFH) ∩ DFGH)=H. Flipping E to H would have score loss of 112. Therefore C is flipped to F, yielding ADEF (4), with a score of 459, as the first sub-ODAG child of ACDE (3).

The integrated mins algorithm also generates the next sibling of ACDE (3). ACDE was generated by flipping B to E. To get its next sibling, the algorithm goes back and performs the next best flip to a target other than E. Therefore, D is flipped to F, yielding ABCF (5), with a score of 477, as a second sub-ODAG child of ABCD (2). ABCF is popped off of sub-ODAG's alternative list. ABCF violates DFGH min rule, so the sub-ODAG process determines which bits of ABCF to flip to fix the violated rule. The target choices are DGH. Flipping A to D would have score loss of 7. B can be flipped only to (BEGH ∩ DFGH)=GH. Flipping B to G would have score loss of 62. C can be flipped only to (CEFH ∩ DFGH)=H. Flipping C to H would have score loss of 124. F cannot be flipped. Therefore, A is flipped to D, yielding BCDF (6), with a score of 470, as the first sub-ODAG child of ABCF (5). There are no more siblings for ABCF. BCDF is popped off of sub-ODAG's alternative list. It passes all the min rules, and is passed back to the ODAG process, where it is determined to pass al of the max rules. BCDF is therefore returned as the optimal solution.

### Example 8a

Transactions of offers A, B, C, D, E have scores 32, 16, 8, 4, 2, 1, respectively. The following rules, M1, M2, m3, and m4, apply:

(M1) Max 3 of ABCDEF

(M2) Not A with D

(m3) Min 2 of DE

(m4) Min 1 of AF

In this example, max rule (M1) is evaluated before max rule (M2) even though the reverse would be more efficient.

The algorithm generates an initial alternative of ABCDEF (1), with a score of 63. The initial alternative passes all of the min rules, but violates max rule (M1). As a result, the ODAG routine proposes a first child alternative of ABC (2), with a score of 56. The child alternative violates rules min rule (m3), and the sub-ODAG routine is called into action. The root of sub-ODAG is ABC. As ABC violates the min rule (m3), the algorithm analyzes the “1” bits (ABC) to determine which to flip and where to fix the violated rule. Flipping A to D would have score loss of 28. Flipping B to D would have score loss of 12. Flipping C to D would have score loss of 4.

Therefore, C is flipped to D, yielding ABD (3), with a score of 52, as the first sub-ODAG child of ABC (2). ABD is put onto sub-ODAG's list, but not on the ODAG's since it still violates min rule (m3). The sub-ODAG routine determines which “1” bits of ABD to modify to produce a result that passes min rule (m3). Flipping A to E would have score loss of 30. Flipping B to E would have score loss of 14. D cannot be flipped.

Therefore, B is flipped to E, yielding ADE (4), with a score 38, as the first sub-ODAG child of ABD (3). ADE is put onto sub-ODAG's list, but not ODAG's, as the algorithm had not yet determined whether it passes all of the min rules.

There are no siblings to generate for ABD, since the target bit of D was already tried. ADE passes all of the min rules and is popped off of sub-ODAG's alternative list. ADE is passed back to the ODAG process as the first child of ABCDEFGH (1). ADE is now on ODAG's list, as it has passed all of the min rules.

ADE is popped off of ODAG's alternative list and found to violate max rule (M2). To fix the broken max rule (M2), the ODAG routine generates a child of AE (5), having a score of 34. This child, however, violates min rule (m3) and is therefore deleted without offspring.

ODAG generates a second child DE (6), with a score of 6, that passes max rule (M3) but that violates rule (m4). Therefore DE is also deleted without offspring.

To generate the next sibling for ADE (4), the algorithm calls the sub-ODAG routine, with ADE on the sub-ODAG list again (the rest of the list was left empty).

ADE is popped off of sub-ODAG's alternative list and passed to the ODAG routine, as it does not violate any min rules. ADE, however, violates max rule (M2). The ODAG routine determines which bits of ADE could be modified to produce a result that passes max rule (M2) and has a minimum score loss. Flipping A to F would have score loss of 31; and D and E cannot be flipped. Therefore, A is flipped to F, yielding DEF (7), with a score of 7, as the first sub-ODAG child of ADE (4). DEF is added to the sub-ODAG list, but not to the ODAG list. The algorithm determines that there are no sub-ODAG siblings to generate for ADE. DEF is popped off of sub-ODAG's alternative list for evaluation against the min rules. It is found to pass all of the min rules, so it is passed back to the ODAG routine as the sibling of ADE (4) and added to the ODAG list. DEF is popped off of ODAG's alternative list for evaluation against the max rules. DEF passes all the rules and is therefore returned as the optimal solution.

To recap Example 8a, one alternative at a time was added to the ODAG list, in the order ABCDEF, ADE, and DEF. These were the only alternatives that passed all of the min rules and thus were allowed onto the ODAG list.

### Example 8b

This is the same as example 8a, except the ODAG routine applies max rule (M2) before max rule (M1). In this example, the application of the max rules in the order from most restrictive (M2) to lease restrictive (M1) improves the efficiency of the algorithm.

As before, the algorithm generates an initial alternative of ABCDEF (1), with a score of 63. The initial alternative passes all of the min rules, but violates max rule (M2). As a result, the ODAG routine proposes a first child alternative of ABCEF (2), with a score of 59, to fix the max rule (M2). ABCEF violates min rule (m3) and is therefore deleted without offspring. The ODAG routine generates a second child of the initial alternative (i.e., a sibling alternative) of BCDEF (3), with a score of 31. BCDEF passes all of the min rules and is therefore added to the ODAG alternative list.

BCDEF is popped off of ODAG's alternative list and the max rules are applied, with max rule (M2) being applied first. BCDEF passes max rule (M2) but violates max rule (M1). To fix the broken max rule (M1), the ODAG routine proposes a first child of BCD (4), with a score of 28. However, BCD violates min rule (m3), and the sub-ODAG routine is called into action. The root of the sub-ODAG tree is BCD. As BCD violates min rule (m3), the algorithm analyzes the “1” bits to determine which to flip and where to fix the violated rule. Flipping B to E would have score loss of 14. Flipping C to E would have score loss of 6. D cannot be flipped. Therefore, C is flipped to E, yielding BDE (5), with a score of 22, as the first sub-ODAG child of BCD (4). BDE is added to the sub-ODAG list, but not to the ODAG list since it violates min rule (m4). The algorithm analyzes the “1” bits of BDE to determine which to flip and where to fix the violated min rule (m4). Flipping B to F would have score loss of 15, and D and E cannot be flipped. Therefore B is flipped to F, yielding DEF (6), with a score of 7, as first sub-ODAG child of BDE (5). DEF is added to the sub-ODAG list, but not to the ODAG list.

There are no siblings to generate for BDE, since the target bit of E was already tried. DEF is popped off of sub-ODAG's alternative list. Since DEF does passes all of the min rules, it is passed back to the ODAG routine as the first child of BCDEF (3). DEF is put onto the ODAG list and evaluated against the max rules. DEF passes all of the max rules and is thus returned as the optimal solution.

In this example, only one alternative at a time was added to the ODAG list, in the order ABCDEF, BCDEF, and DEF. These were the only alternatives that passed all of the min rules and thus were allowed onto the ODAG list.

### Example 8c

This is the same as example 8b, except that max rule (M2) has changed from “Not A with D” to “Max 1 of AD”. These rules have the same meaning, but they are processed in slightly different ways. If the children of a “Not X with Y” rule break any min rules, they are simply deleted; while if the children of a more general max rule break any min rules, they are passed into sub-ODAG to be “fixed” if possible. This example demonstrates the role played by the combo set in affecting which alternatives are handed to the sub-ODAG routine.

The algorithm generates an initial alternative of ABCDEF (1), with a score of 63. The initial alternative passes all of the min rules, but violates max rule (M2). As a result, the ODAG routine proposes a first child alternative of ABCEF (2), with a score of 59, to fix the broken max rule (M2). ABCEF violates min rule (m3) and so sub-ODAG is called into action. In Example 8b, by contrast, ABCEF was simply deleted without offspring.

The combo set for the first child was AD, so only those bits are passed into sub-ODAG, as “10” (meaning A=1 and D=0). The min rules are adjusted since E and F are ON outside of the scope of the combo set. So min rule (m3) becomes “Min 1 of D” and min rule (m4) disappears.

The root of the sub-ODAG tree is AD, which is expressed as “10” (i.e. just A) (3). The sub-ODAG routine determines which bits to flip in order to fix the broken min rule (m3). Flipping A to D would have score loss of 28. Therefore A is flipped to D, yielding “01” (i.e. just D) (4) as the first sub-ODAG child of AD.

No mins rules are violated by “01”, and it is passed back to the ODAG routine, where the non-combo bits are restored, yielding BCDEF (5), with a score of 31, as the first ODAG child of ABCDEF (1). BCDEF is added to the ODAG alternative list and evaluated against the max rules. It is found to violate max rule (M1), so the ODAG routine generates a first child of BCD (6), with a score of 28, to fix the rule. BCD, however, violates min rule (m3) and so a different instantiation of sub-ODAG is called into action. The root of the sub-ODAG tree is BCD. The sub-ODAG routine attempts to modify BCD to produce a result that passes min rule (m3). Flipping B to E would have score loss of 14. Flipping C to E would have score loss of 6. D cannot be flipped. Therefore C is flipped to E, yielding BDE (7), with a score of 22, as the first sub-ODAG child of BCD. BDE is added to the sub-ODAG list and evaluated with respect to the min rules. BDE violates min rule (m4); therefore, the sub-ODAG routine attempts to modify BDE to produce a result that passes this violated min rule. Flipping B to F would have score loss of 15, and D and E cannot be flipped. Therefore B is flipped to F, yielding DEF, with a score of 7, as first sub-ODAG child of BDE. DEF is added to this sub-ODAG list. There are no siblings to generate for BDE, since the target bit of E was already tried.

DEF is popped off of this sub-ODAG's list and evaluated with respect to the min rules. Since DEF passes all of the min rules, it is passed back to the ODAG routine as first child of BCDEF (5) and added to the ODAG alternative list.

The next ODAG sibling for BCDEF (5) (which is also the second child of ABCDEF (1) is generated, and is a duplicate of BCDEF. Because BCDEF is a duplicate, it cannot have any children. It also has no additional siblings.

DEF is popped off of the ODAG alternative list and evaluated with respect to the max rules. It passes all of the max rules and is therefore returned as the optimal solution. In this example, only one alternative at a time was added to the ODAG list, in the order ABCDEF, BCDEF, and DEF. These were the only alternatives that passed all of the min rules and thus were allowed onto the ODAG list.

A number of embodiments of the invention have been described. Nevertheless, it will be understood that various modifications may be made without departing from the spirit and scope of the invention. The foregoing are examples for illustration only and not to limit the alternatives in any way.

The processes described herein can be implemented in digital electronic circuitry, or in computer software, firmware, or hardware, including the structural means disclosed in this specification and structural equivalents thereof, or in combinations of them. The processes can be implemented as one or more computer program products, i.e., one or more computer programs tangibly embodied in an information carrier, e.g., in a machine readable storage device or in a propagated signal, for execution by, or to control the operation of, data processing apparatus, e.g., a programmable processor, a computer, or multiple computers. A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes described herein, including method steps, can be performed by one or more programmable processors executing one or more computer programs to perform functions of the processes by operating on input data and generating output. The processes can also be performed by, and apparatus of the processes can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Computer-readable media suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The processes can be implemented in a computing system that includes a back end component (e.g., a data server), a middleware component (e.g., an application server), or a front end component (e.g., a client computer having a graphical user interface or a Web browser through which a user can interact with an implementation of the processes), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The ordering of steps of processes are not confined to the orders shown in the figures and may be re-ordered, repeated, interleaved with each other and/or with additional steps as appropriate. Accordingly, other embodiments are within the scope of the following claims.

What is claimed is:

1. A computer-implemented method for combinatorial optimization:
selecting a first combination of offers from a list of combinations of offers that pass a first set of rules belonging to a first category of rules, the offers in the list of combinations of offers having assigned scores associated with sending the offers to proposed contacts;
determining whether the first combination of offers passes a second set of rules belonging to a second, different category of rules;
if the first combination violates one or more rules of the second set of rules, modifying one or more of the offers of the first combination to generate a second combination of offers that complies with the second set of rules; and
if the first combination passes the second set of rules, returning the first combination as a solution.

2. The method of claim 1, wherein the solution is applicable to a marketing campaign.

3. The method of claim 1, wherein the first category of rules includes min rules and the second category of rules include max rules,
the min rules specifying that at least M offers from set S of offers are sent to any contact of the marketing campaign or that a first offer may only be included with a second offer; and
the max rules specifying that no more than M offers from set S of offers may be sent to any contact of the marketing campaign.

4. The method of claim 1, further comprising:
determining that the second combination of offers passes the first set of rules; and
adding the second combination of offers to the list of combinations.

5. The method of claim 1, further comprising:
determining that the second combination of offers violates one or more rules from the first set of rules;
modifying one or more of the offers of the second combination to generate a third combination of offers that complies with the first set of rules; and
adding the third combination of offers to the list of combinations.

6. The method of claim 4, wherein modifying comprises:
violating a first rule of the first set of rules to comply with a second rule of the first set of rules, wherein violating generates a result; and
modifying the result to comply with the first rule.

7. The method of claim 1, further comprising:
organizing the combinations of offers in the list in descending order according to scores associated with the combinations of offers, wherein the first combination of offers has a score that is higher than the scores of the other combinations in the list.

8. The method of claim 1, further comprising:
ordering the second set of rules by the most restrictive first; and
wherein determining further comprises applying each rule of the second set, one by one and in order, to the first combination.

9. The method of claim 1, further comprising:
iteratively
(1) applying the first set of rules to combinations of offers that pass the second set of rules,
modifying the combinations to comply with one or more of the first set of rules; and
adding the modified combinations to the list; and
(2) applying the second set of rules to combinations of offers in the list in descending order according to scores associated with the combinations of offers;
modifying the combinations to comply with one or more of the second set
of rules, until a final combination that satisfies both sets of rules is determined, the final combination being an optimal solution to a marketing campaign.

10. The method of claim 1, further comprising:
storing a first set of state information corresponding to the first combination of offers; and wherein modifying results from manipulating the first set of state information.

11. The method of claim 1, wherein modifying comprises removing the one or more offers from the first combination of offers.

12. The method of claim 1, wherein modifying comprises replacing the one or more offers of the first combination with one or more different offers.

13. The method of claim 1, wherein the rules of the first and second sets of rules and the first combination are represented by strings of bits corresponding to offers, and wherein modifying further comprises:
performing an AND operation between the bits of the one or more rules that are violated and the bits of the first combination of offers to generate a combo set, wherein the combo set includes a combo set including a set of “on” bits and any intervening bits;
adjusting bits outside the combo set according to rules that govern how violated rules of the first category may be repaired; and
returning the combo set as the second combination of offers.

14. The method of claim 1, wherein modifying one or more of the offers of the first combination to generate a second combination of offers that complies with the second set of rules further comprises:
determining information associated with how the one or more rules of the second set of rules are violated by the one or more offers of the first combination; and
using the information to modify the one or more offers.

15. The method of claim 1, further comprising:
organizing the list of combinations of offers that pass a first set of rules as a tree structure.

16. The method of claim 15, further comprising:
generating next highest scoring combinations of offers one at a time and on-demand; and
storing the generated next highest scoring combinations of offers in the tree structure.

17. A computer readable medium having stored thereon, software for combinatorial optimization, the software comprising instructions for causing one or more processors to:
select a first combination of offers from a list of combinations of offers that pass a first set of rules belonging to a first category of rules, the offers in the list of combinations of offers having assigned scores associated with sending the offers to proposed contacts;
determine whether the first combination of offers passes a second set of rules belonging to a second, different category of rules;
if the first combination violates one or more rules of the second set of rules, modify one or more of the offers of the first combination to generate a second combination of offers that complies with the second set of rules; and
if the first combination passes the second set of rules, return the first combination as a solution.

18. The computer readable medium of claim 17, wherein the solution is applicable to a marketing campaign.

19. The computer readable medium of claim 17, wherein the first category of rules includes min rules and the second category of rules include max rules,
the min rules specifying that at least M offers from set S of offers are sent to any contact of the marketing campaign or that a first offer may only be included with a second offer; and
the max rules specifying that no more than M offers from set S of offers may be sent to any contact of the marketing campaign.

20. The computer readable medium of claim 17, wherein the software further comprises instructions that cause the one or more processors to:
determine that the second combination of offers passes the first set of rules; and
add the second combination of offers to the list of combinations.

21. The computer readable medium of claim 17, wherein the software further comprises instructions that cause the one or more processors to:
determine that the second combination of offers violates one or more rules from the first set of rules;
modify one or more of the offers of the second combination to generate a third combination of offers that complies with the first set of rules; and
add the third combination of offers to the list of combinations.

22. The computer readable medium of claim 20, wherein the software further comprises instructions that cause the one or more processors to:
violate a first rule of the first set of rules to comply with a second rule of the first set of rules, wherein violating generates a result; and
modify the result to comply with the first rule.

23. The computer readable medium of claim 17, wherein the software further comprises instructions that cause the one or more processors to:
organize the combinations of offers in the list in descending order according to scores associated with the combinations of offers, wherein the first combination of offers has a score that is higher than the scores of the other combinations in the list.

24. The computer readable medium of claim 17, wherein the software further comprises instructions that cause the one or more processors to:
order the second set of rules by the most restrictive first; and
apply each rule of the second set, one by one and in order, to the first combination.

25. The computer readable medium of claim 17, wherein the software further comprises instructions that cause the one or more processors to:
iteratively
(1) apply the first set of rules to combinations of offers that pass the second set of rules,
modify the combinations to comply with one or more of the first set of rules; and
add the modified combinations to the list; and
(2) apply the second set of rules to combinations of offers in the list in descending order according to scores associated with the combinations of offers;
modify the combinations to comply with one or more of the second set of rules, until a final combination that satisfies both sets of rules is determined,
the final combination being an optimal solution to a marketing campaign.

26. The computer readable medium of claim 17, wherein the software further comprises instructions that cause the one or more processors to:
store a first set of state information corresponding to the first combination of offers; and
manipulate the first set of state information.

27. The computer readable medium of claim 17, wherein the software further comprises instructions that cause the one or more processors to remove the one or more offers from the first combination of offers.

28. The computer readable medium of claim 17, wherein the software further comprises instructions that cause the one or more processors to replace the one or more offers of the first combination with one or more different offers.

29. The computer readable medium of claim 17, wherein the rules of the first and second sets of rules and the first combination are represented by strings of bits corresponding to offers, and wherein the software further comprises instructions that cause the one or more processors to:
perform an AND operation between the bits of the one or more rules that are violated and the bits of the first combination of offers to generate a combo set, wherein the combo set includes a combo set including a set of “on” bits and any intervening bits;
adjust bits outside the combo set according to rules that govern how violated rules of the first category may be repaired; and
return the combo set as the second combination of offers.

30. The computer readable medium of claim 17, wherein the software further comprises instructions that cause the one or more processors to:
determine information associated with how the one or more rules of the second set of rules are violated by the one or more offers of the first combination; and
use the information to modify the one or more offers.

31. The computer readable medium of claim 17, wherein the software further comprises instructions that cause the one or more processors to organize the list of combinations of offers that pass a first set of rules as a tree structure.

32. The computer readable medium of claim 31, wherein the software further comprises instructions that cause the one or more processors to:
generate next highest scoring combinations of offers one at a time and on-demand; and
store the generated next highest scoring combinations of offers in the tree structure.

33. A system for combinatorial optimization, the system comprising:
memory configured to store a list of combinations of offers that pass a first set of rules belonging to a first category of rules, the offers in the list of combinations of offers having assigned scores associated with sending the offers to proposed contacts; and
one or more processors configured to:
select a first combination of offers from the list;
determine whether the first combination of offers passes a second set of rules belonging to a second, different category of rules;
if the first combination violates one or more rules of the second set of rules, modify one or more of the offers of the first combination to generate a second combination of offers that complies with the second set of rules; and
if the first combination passes the second set of rules, return the first combination as a solution.

34. The system of claim 33, wherein the solution is applicable to a marketing campaign.

35. The system of claim 33, wherein the first category of rules includes min rules and the second category of rules include max rules,
the min rules specifying that at least M offers from set S of offers are sent to any contact of the marketing campaign or that a first offer may only be included with a second offer; and
the max rules specifying that no more than M offers from set S of offers may be sent to any contact of the marketing campaign.

36. The system of claim 33, wherein the one or more processors are further configured to:
determine that the second combination of offers passes the first set of rules; and
add the second combination of offers to the list of combinations.

37. The system of claim 33, wherein the one or more processors are further configured to:
determine that the second combination of offers violates one or more rules from the first set of rules;
modify one or more of the offers of the second combination to generate a third combination of offers that complies with the first set of rules; and
add the third combination of offers to the list of combinations.

38. The system of claim 36, wherein the one or more processors are further configured to:
violate a first rule of the first set of rules to comply with a second rule of the first set of rules, wherein violating generates a result; and
modify the result to comply with the first rule.

39. The system of claim 33, wherein the one or more processors are further configured to:
organize the combinations of offers in the list in descending order according to scores associated with the combinations of offers, wherein the first combination of offers has a score that is higher than the scores of the other combinations in the list.

40. The system of claim 33, wherein the one or more processors are further configured to:
order the second set of rules by the most restrictive first; and
apply each rule of the second set, one by one and in order, to the first combination.

41. The system of claim 33, wherein the one or more processors are further configured to:
iteratively
(1) apply the first set of rules to combinations of offers that pass the second set of rules,
modify the combinations to comply with one or more of the first set of rules; and
add the modified combinations to the list; and
(2) apply the second set of rules to combinations of offers in the list in descending order according to scores associated with the combinations of offers;
modify the combinations to comply with one or more of the second set of rules, until a final combination that satisfies both sets of rules is determined,
the final combination being an optimal solution to a marketing campaign.

42. The system of claim 33, wherein the one or more processors are further configured to:
store a first set of state information corresponding to the first combination of offers; and
manipulate the first set of state information.

43. The system of claim 33, wherein the one or more processors are further configured to remove the one or more offers from the first combination of offers.

44. The system of claim 33, wherein the one or more processors are further configured to replace the one or more offers of the first combination with one or more different offers.

45. The system of claim 33, wherein the rules of the first and second sets of rules and the first combination are represented by strings of bits corresponding to offers, and wherein the one or more processors are further configured to:
perform an AND operation between the bits of the one or more rules that are violated and the bits of the first combination of offers to generate a combo set, wherein the combo set includes a combo set including a set of “on” bits and any intervening bits;
adjust bits outside the combo set according to rules that govern how violated rules of the first category may be repaired; and
return the combo set as the second combination of offers.

46. The system of claim 33, wherein the one or more processors are further configured to:
determine information associated with how the one or more rules of the second set of rules are violated by the one or more offers of the first combination; and
use the information to modify the one or more offers.

47. The system of claim 33, wherein the one or more processors are further configured to organize the list of combinations of offers that pass a first set of rules as a tree structure.

48. The system of claim 47, wherein the one or more processors are further configured to:
generate next highest scoring combinations of offers one at a time and on-demand; and
store the generated next highest scoring combinations of offers in the tree structure.
